(19) United States
(12) Patent Application Publication
(10) Pub. No.: US 2026/0317982 A1
(43) Pub. Date: Oct. 15, 2026

(54) CLOTHES TREATING APPARATUS AND METHOD OF CONTROLLING THE SAME

(71) Applicant: Samsung Electronics Co., Ltd., Suwon-si (KR)

(72) Inventors: Changwoo LEE, Suwon-si (KR); Dongyoung KIM, Suwon-si (KR); Hyunseok BAE, Suwon-si (KR); Seungwan YOO, Suwon-si (KR); Gyumin CHOI, Suwon-si (KR)

(21) Appl. No.: 19/465,328

(22) Filed: Jan. 30, 2026

Related U.S. Application Data
(63) Continuation of application No. PCT/KR2025/022563, filed on Dec. 23, 2025.

(30) Foreign Application Priority Data
Dec. 31, 2024 (KR) 10-2024-0202862
Mar. 21, 2025 (KR) 10-2025-0036877

(51) Int. Cl. D06F 33/54; A62C 3/00; D06F 33/62; D06F 33/63; D06F 33/70; D06F 33/74; D06F 34/26; D06F 103/18; D06F 103/32; D06F 103/38; D06F 103/54; D06F 105/02; D06F 105/08; D06F 105/48

(52) U.S. Cl. CPC D06F 33/54; A62C 3/00; D06F 33/62; D06F 33/63; D06F 33/70; D06F 33/74; D06F 34/26; D06F 2103/18; D06F 2103/32; D06F 2103/38; D06F 2103/54; D06F 2105/02; D06F 2105/08; D06F 2105/48

(57) ABSTRACT

A clothes treating apparatus is provided. The clothes treating apparatus includes a housing, a tub provided inside the housing, a drum provided inside the tub and configured to accommodate laundry, a driving device configured to provide rotational force to the drum, a water supply device configured to supply water from an external water source into the tub, a hot air supply device including a heater configured to heat air and a fan configured to blow the air heated by the heater into the tub, a discharge device including a discharge flow path configured to guide moist air discharged from the tub to the outside, a plurality of temperature sensors provided on the discharge flow path of the discharge device and configured to detect a temperature, memory, including one or more storage media, storing instructions, and one or more processors communicatively coupled to the driving device, the water supply device, the hot air supply device, the plurality of temperature sensors, and the memory, wherein the instructions, when executed by the one or more processors individually or collectively, cause the clothes treating apparatus to control the driving device such that the drum rotates at a defined rotational speed, and control the water supply device to supply water into the drum, based on a temperature detected by one of the plurality of temperature sensors being equal to or higher than a defined target temperature.

### CROSS-REFERENCE TO RELATED APPLICATION(S)

This application is a continuation application, claiming priority under 35 U.S.C. §365(c), of an International application No. PCT/KR2025/022563, filed on Dec. 23, 2025, which is based on and claims the benefit of a Korean patent application number 10-2024-0202862, filed on Dec. 31, 2024, in the Korean Intellectual Property Office, and of a Korean patent application number 10-2025-0036877, filed on Mar. 21, 2025, in the Korean Intellectual Property Office, the disclosure of each of which is incorporated by reference herein in its entirety.

### TECHNICAL FIELD

The disclosure relates to a clothes treating apparatus including a drying device, and a method of controlling thereof.

### BACKGROUND ART

A clothes treating apparatus is a device for treating and/or managing clothes. The clothes treating apparatus may include a washing machine and a dryer. The washing machine may include a washer-dryer combination.

The washer-dryer combination is a device that uses a driving force of a driving motor to agitate laundry, water, and detergent, which are put into a tub together, so as to wash the laundry through mutual friction.

Operations performed by the washer-dryer combination may include a washing operation in which detergent and water are supplied to the tub storing the laundry and the laundry is rotated while the drum is rotated, a rinsing operation in which water is supplied to the tub and the drum is rotated to rinse the laundry, and a spin-drying operation in which water is discharged from the tub and the drum is rotated to remove moisture from the laundry.

The operations performed by the washer-dryer combination may include a drying operation in which the laundry is dried by blowing heated air generated from a drying device into a space containing the laundry. The washer-dryer combination may include the drying device to perform the drying operation.

The above information is presented as background information only to assist with an understanding of the disclosure. No determination has been made, and no assertion is made, as to whether any of the above might be applicable as prior art with regard to the disclosure.

### DISCLOSURE

### Technical Problem

Aspects of the disclosure are to address at least the above-mentioned problems and/or disadvantages and to provide at least the advantages described below. Accordingly, an aspect of the disclosure is to provide a clothes treating apparatus and a method of controlling the clothes treating apparatus, which include a temperature sensor configured to detect the temperature of heated air supplied to a drum.

### Technical Solution

In accordance with an aspect of the disclosure, a clothes treating apparatus is provided. The clothes treating apparatus includes a housing, a tub provided inside the housing, a drum provided inside the tub and configured to accommodate laundry, a driving device configured to provide rotational force to the drum, a water supply device configured to supply water from an external water source into the tub, a hot air supply device including a heater configured to heat air and a fan configured to blow the air heated by the heater into the tub, a discharge device including a discharge flow path configured to guide moist air discharged from the tub to the outside, a plurality of temperature sensors provided on the discharge flow path of the discharge device and configured to detect a temperature, memory, comprising one or more storage media, storing instructions, and one or more processors communicatively coupled to the driving device, the water supply device, the hot air supply device, the plurality of temperature sensors, and the memory, wherein the instructions, when executed by the one or more processors individually or collectively, cause the clothes treating apparatus to control the driving device such that the drum rotates at a defined rotational speed and control the water supply device to supply water into the drum, based on a temperature detected by one of the plurality of temperature sensors being equal to or higher than a defined target temperature.

In accordance with another aspect of the disclosure, a method of controlling a clothes treating apparatus, wherein the clothes treating apparatus includes a housing, a tub provided inside the housing, a drum provided inside the tub and configured to accommodate laundry, a driving device configured to provide rotational force to the drum, a water supply device configured to supply water from an external water source into the tub, a hot air supply device including a heater for heating air and a fan for blowing the heated air into the tub, a discharge device including a discharge flow path for guiding air discharged from the tub to the outside, and a plurality of temperature sensors provided on the discharge flow path of the discharge device and configured to detect a temperature is provided. The method includes performing a drying operation by driving the hot air supply device, and controlling the driving device such that the drum rotates at a defined rotational speed, and controlling the water supply device to supply water into the drum, based on a temperature detected by one of the plurality of temperature sensors being equal to or higher than a defined target temperature.

In accordance with another aspect of the disclosure, One or more non-transitory computer-readable storage media storing one or more computer programs including computer-executable instructions that, when executed by one or more processors of a clothes treating apparatus individually or collectively, cause the clothes treating apparatus to perform operations is provided. The operations include performing a drying operation by driving a hot air supply device, controlling a driving device such that a drum rotates at a defined rotational speed, and controlling a water supply device to supply water into the drum, based on a temperature detected by one of a plurality of temperature sensors being equal to or higher than a defined target temperature.

An aspect of the disclosure is to provide a clothes treating apparatus with improved safety through fire detection and fire suppression operations.

Another aspect of the disclosure is to provide a clothes treating apparatus with enhanced accuracy in fire prediction by identifying abnormalities of the temperature sensor.

Other aspects, advantages, and salient features of the disclosure will become apparent to those skilled in the art from the following detailed description, which, taken in conjunction with the annexed drawings, discloses various embodiments of the disclosure.

### DESCRIPTION OF DRAWINGS

The above and other aspects, features, and advantages of certain embodiments of the disclosure will be more apparent from the following description taken in conjunction with the accompanying drawings, in which:

FIG. 1 illustrates a clothes treating apparatus according to an embodiment of the disclosure;

FIG. 2 illustrates the clothes treating apparatus when viewed from a direction different from the direction illustrated in FIG. 1 according to an embodiment of the disclosure;

FIG. 3 illustrates a cross-section of the clothes treating apparatus according to an embodiment of the disclosure;

FIG. 4 illustrates some components arranged inside the clothes treating apparatus according to an embodiment of the disclosure;

FIG. 5 illustrates some components arranged inside the clothes treating apparatus when viewed from a direction different from the direction illustrated in FIG. 4 according to an embodiment of the disclosure;

FIG. 6 illustrates a state in which a drying device of the clothes treating apparatus is disassembled from a tub according to an embodiment of the disclosure;

FIG. 7 illustrates a state in which the drying device of the clothes treating apparatus is disassembled from the tub when viewed from a direction different from the direction illustrated in FIG. 6 according to an embodiment of the disclosure;

FIG. 8 illustrates a state in which a hot air supply device and a discharge device of a drying device of the clothes treating apparatus are disassembled from a drying case according to an embodiment of the disclosure;

FIG. 9 illustrates the interior of the hot air supply device and the discharge device by disassembling some components of the drying device of the clothes treating apparatus according to an embodiment of the disclosure;

FIG. 10 illustrates the interior of the hot air supply device and the discharge device with some components of the drying device of the clothes treating apparatus disassembled, when viewed from a direction different from the direction illustrated in FIG. 9 according to an embodiment of the disclosure;

FIG. 11 is a control block diagram of the clothes treating apparatus according to an embodiment of the disclosure;

FIG. 12 is a flowchart illustrating a method of controlling the clothes treating apparatus according to an embodiment of the disclosure;

FIG. 13 is a flowchart illustrating a process of identifying an abnormality of a temperature sensor in the method of controlling the clothes treating apparatus according to an embodiment of the disclosure;

FIG. 14 is a flowchart illustrating a process of detecting a fire and performing a fire extinguishing operation in the method of controlling the clothes treating apparatus according to an embodiment of the disclosure; and

FIG. 15 is a flowchart illustrating a process of identifying whether fire extinguishment is complete in the method of controlling the clothes treating apparatus according to an embodiment of the disclosure.

Throughout the drawings, it should be noted that like reference numbers are used to depict the same or similar elements, features, and structures.

### MODES OF THE INVENTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In describing of the drawings, similar reference numerals may be used for similar or related elements.

In the disclosure, phrases, such as “A or B,” “at least one of A and B,” “at least one of A or B,” “A, B or C,” “at least one of A, B and C,” and “at least one of A, B, or C” may include any one or all possible combinations of the items listed together in the corresponding phrase among the phrases.

As used herein, the term “and/or” includes any and all combinations of one or more of the associated listed items.

Terms such as “1^{st},” “2^{nd},” “primary,” or “secondary” may be used simply to distinguish an element from other elements, without limiting the element in other aspects (e.g., importance or order).

When an element (e.g., a first element) is referred to as being “(functionally or communicatively) coupled” or “connected” to another element (e.g., a second element), the first element may be connected to the second element, directly (e.g., wired), wirelessly, or through a third element.

It will be understood that when the terms “includes,” “comprises,” “including,” and/or “comprising” are used in the disclosure, they specify the presence of the specified features, figures, steps, operations, components, members, or combinations thereof, but do not preclude the presence or addition of one or more other features, figures, steps, operations, components, members, or combinations thereof.

When a given element is referred to as being “connected to,” “coupled to,” “supported by” or “in contact with” another element, it is to be understood that it may be directly or indirectly connected to, coupled to, supported by, or in contact with the other element. When a given element is indirectly connected to, coupled to, supported by, or in contact with another element, it is to be understood that it may be connected to, coupled to, supported by, or in contact with the other element through a third element.

It will also be understood that when an element is referred to as being “on” another element, it may be directly on the other element or intervening elements may also be present.

A washing machine according to various embodiments may perform washing, rinsing, spin-drying, and drying processes. The washing machine is an example of a clothes treating apparatus, and the clothes treating apparatus is a concept including a device capable of washing clothes (objects to be washed, and objects to be dried), a device capable of drying clothes, and a device capable of washing and drying clothes.

The washing machine according to various embodiments may include a top-loading washing machine in which a laundry inlet for inserting or removing laundry is provided to face upward, or a front-loading washing machine in which a laundry inlet is provided to face forward. The washing machine according to various embodiments may include a washing machine of a loading type other than the top-loading washing machine and the front-loading washing machine.

For the top-loading washing machine, laundry may be washed using water current generated by a rotating body such as a pulsator. For the front-loading washing machine, laundry may be washed by repeatedly lifting and lowering laundry by rotating a drum. The front-loading washing machine may include a dryer combined washing machine capable of drying laundry stored in a drum. The dryer combined washing machine may include a hot air supply device for supplying high-temperature air into the drum. For example, the dryer combined washing machine may include a heater. The washing machine according to various embodiments may include a washing machine using a washing method other than the above-described washing method.

The washing machine according to various embodiments may include a housing accommodating various components therein. The housing may be provided in the form of a box including a laundry inlet on one side thereof.

The washing machine may include a door for opening and closing the laundry inlet. The door may be rotatably mounted to the housing by a hinge. At least a portion of the door may be transparent or translucent to allow the inside of the housing to be visible.

The washing machine may include a tub disposed within the housing to store water. The tub may be formed in a substantially cylindrical shape with a tub opening formed on one side thereof. The tub may be disposed inside the housing in such a way that the tub opening corresponds to the laundry inlet.

The tub may be connected to the housing by a damper. The damper may absorb vibration generated when the drum rotates, and the damper may reduce vibration transmitted to the housing.

The washing machine may include a drum provided to accommodate laundry.

The drum may be disposed inside the tub such that a drum opening provided on one side of the drum corresponds to the laundry inlet and the tub opening. Laundry may pass sequentially through the laundry inlet, the tub opening, and the drum opening and then be received in the drum or removed from the drum.

The drum may perform each operation according to washing, rinsing, and/or spin-drying while rotating in the tub. A plurality of through holes may be formed in a cylindrical wall of the drum to allow water stored in the tub to be introduced into or to be discharged from the drum.

The washing machine may include a driving device configured to rotate the drum. The driving device may include a drive motor and a rotating shaft for transmitting a driving force generated by the drive motor to the drum. The rotating shaft may penetrate the tub to be connected to the drum.

The driving device may perform respective operations according to washing, rinsing, and/or spin-drying, or drying processes by rotating the drum in a forward or reverse direction.

The washing machine may include a water supply device configured to supply water to the tub. The water supply device may include a water supply pipe and a water supply valve disposed in the water supply pipe. The water supply pipe may be connected to an external water supply source. The water supply pipe may extend from an external water supply source to a detergent supply device and/or the tub. Water may be supplied to the tub through the detergent supply device. Alternatively, water may be supplied to the tub without passing through the detergent supply device.

The water supply valve may open or close the water supply pipe in response to an electrical signal from a controller. The water supply valve may allow or block the supply of water to the tub from an external water supply source. The water supply valve may include a solenoid valve configured to open or close in response to an electrical signal.

The washing machine may include the detergent supply device configured to supply detergent to the tub. The detergent supply device may include a manual detergent supply device that requires a user to enter detergent to be used for each washing, and an automatic detergent supply device that stores a large amount of detergent and automatically adds a defined amount of detergent during washing. The detergent supply device may include a detergent container for storing detergent. The detergent supply device may be configured to supply detergent into the tub during a water supply process. Water supplied through the water supply pipe may be mixed with detergent via the detergent supply device. Water mixed with detergent may be supplied into the tub. Detergent is used as a term including detergent for pre-washing, detergent for main washing, fabric softener, bleach, etc., and the detergent container may be partitioned into a storage region for the pre-washing detergent, a storage region for the main washing detergent, a storage region for the fabric softener, and a storage region for the bleach.

The washing machine may include a drainage device configured to discharge water contained in the tub to the outside. The drainage device may include a drain pipe extending from a bottom of the tub to the outside of the housing, a drain valve disposed on the drain pipe to open or close the drain pipe, and a pump disposed on the drain pipe. The pump may pump water from the drain pipe to the outside of the housing.

The washing machine may include a control panel disposed on one side of the housing. The control panel may provide a user interface for interaction between a user and the washing machine. The user interface may include at least one input interface and at least one output interface.

The at least one input interface may convert sensory information received from a user into an electrical signal.

The at least one input interface may include a power button, an operation button, a course selection dial (or a course selection button), and a washing/rinsing/spin-drying setting button. The at least one input interface may include a tact switch, a push switch, a slide switch, a toggle switch, a micro switch, a touch switch, a touch pad, a touch screen, a jog dial, and/or a microphone.

The at least one output interface may visually or audibly transmit information related to the operation of the washing machine to a user.

For example, the at least one output interface may transmit information related to a washing course, operation time of the washing machine, and washing/rinsing/spin-drying settings to the user. Information about the operation of the washing machine may be output via a screen, an indicator, or a voice. The at least one output interface may include a liquid crystal display (LCD) panel, a light emitting diode (LED) panel, or a speaker.

The washing machine may include a communication module for wired and/or wireless communication with an external device.

The communication module may include at least one of a short-range wireless communication module or a long-range wireless communication module.

The communication module may transmit data to an external device (e.g., a server, a user device, and/or a home appliance) or receive data from the external device. For example, the communication module may establish communication with a server and/or a user device and/or a home appliance, and transmit and receive various types of data.

For the communication, the communication module may establish a direct (e.g., wired) communication channel or a wireless communication channel between the external devices, and support the performance of the communication through the established communication channel. According to an embodiment, the communication module may include a wireless communication module (e.g., a cellular communication module, a short-range wireless communication module, or a global navigation satellite system (GNSS) communication module) or a wired communication module (e.g., a local area network (LAN) communication module, or a power line communication module). Among these communication modules, the corresponding communication module may communicate with an external device through a first network (e.g., a short-range wireless communication network such as Bluetooth, wireless fidelity (Wi-Fi) direct, or infrared data association (IrDA)) or a second network (e.g., a long-range wireless communication network such as a legacy cellular network, a 5G network, a next-generation communication network, the Internet, or a computer network (e.g., LAN or wide area network WAN)). These various types of communication modules may be integrated as a single component (e.g., a single chip) or implemented as a plurality of separate components (e.g., multiple chips).

The short-range wireless communication module may include a Bluetooth communication module, a Bluetooth Low Energy (BLE) communication module, a near field communication module, a WLAN (Wi-Fi) communication module, and a Zigbee communication module, an IrDA communication module, a Wi-Fi Direct (WFD) communication module, an ultrawideband (UWB) communication module, an Ant+ communication module, a microwave (uWave) communication module, etc., but is not limited thereto.

The long-range wireless communication module may include a communication module that performs various types of long-range wireless communication, and may include a mobile communication circuitry. The mobile communication circuitry transmits and receives radio signals with at least one of a base station, an external terminal, or a server in a mobile communication network.

According to an embodiment, the communication module may communicate with an external device such as a server, a user device and other home appliances through an access point (AP). The AP may connect a LAN, to which a washing machine or a user device is connected, to a WAN to which a server is connected. The washing machine or the user device may be connected to the server via the WAN. The controller may control various components of the washing machine (e.g., the drive motor, and the water supply valve). The controller may control various components of the washing machine to perform at least one operation including water supply, washing, rinsing, and/or spin-drying according to a user input. For example, the controller may control the drive motor to adjust the rotational speed of the drum or control the water supply valve of the water supply device to supply water to the tub.

The controller may include hardware such as a CPU or memory, and software such as a control program. For example, the controller may include at least one memory for storing an algorithm and program-type data for controlling the operation of components in the washing machine, and at least one processor configured to perform the above-mentioned operation by using the data stored in the at least one memory. The memory and the processor may each be implemented as separate chips. The processor may include one or more processor chips or may include one or more processing cores. The memory may include one or more memory chips or one or more memory blocks. Alternatively, the memory and the processor may be implemented as a single chip.

Hereinafter a clothes treating apparatus according to various embodiments will be specifically described with reference to the attached drawings. Hereinafter a washer-dryer combination will be described as an example of a clothes treating apparatus, but the disclosure is not limited to the washer-dryer combination, and may be applied to various devices for treating and/or managing clothes.

In the following detailed description, the terms of “front side”, “rear side”, “left side”, “right side” and the like may be defined by the drawings, but the shape and the location of the element is not limited by the term.

For example, the X-axis direction may be defined as the front and rear direction, the Y-axis direction may be defined as the left and right direction, and the Z-axis direction may be defined as the up and down direction.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

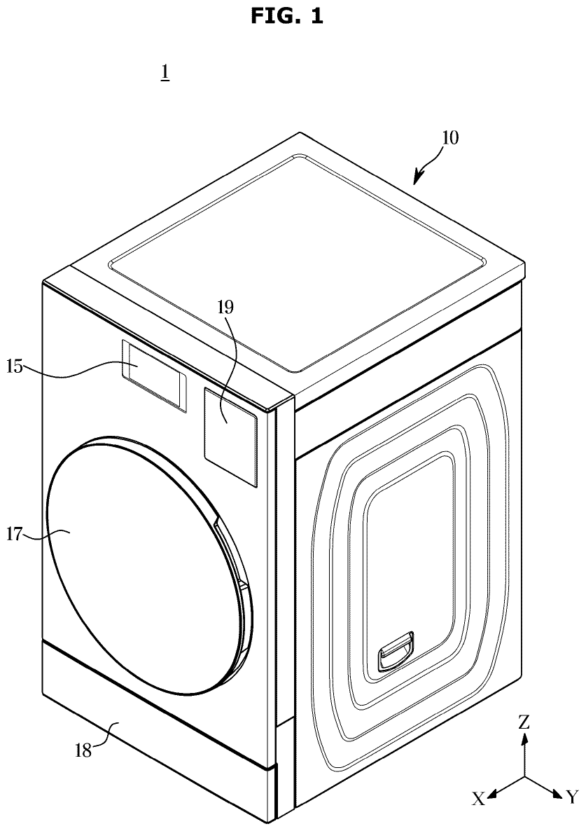

FIG. 1 illustrates a clothes treating apparatus according to an embodiment of the disclosure.

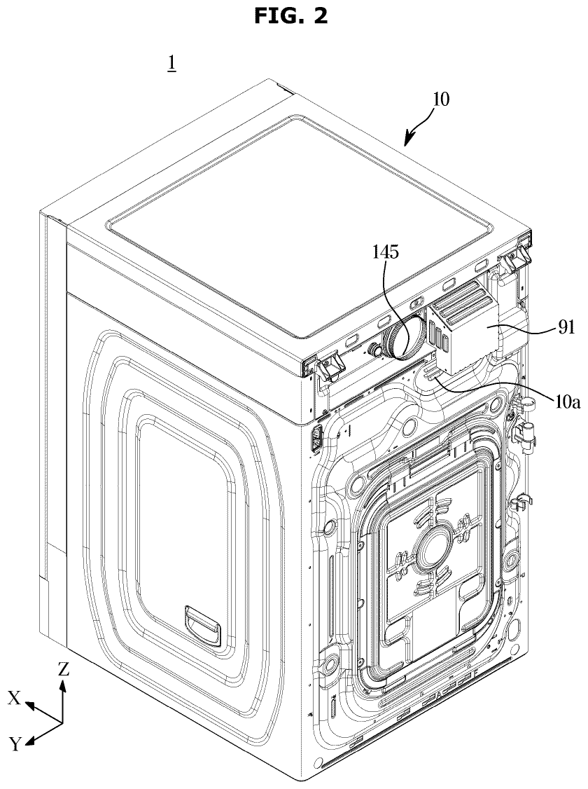

FIG. 2 illustrates the clothes treating apparatus viewed from a direction different from the direction illustrated in FIG. 1 according to an embodiment of the disclosure.

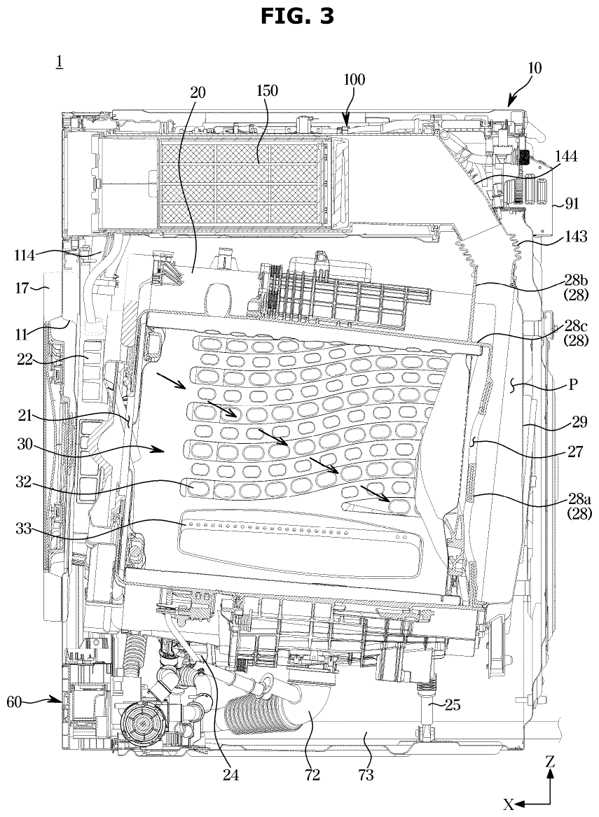

FIG. 3 illustrates a cross-section of the clothes treating apparatus according to an embodiment of the disclosure.

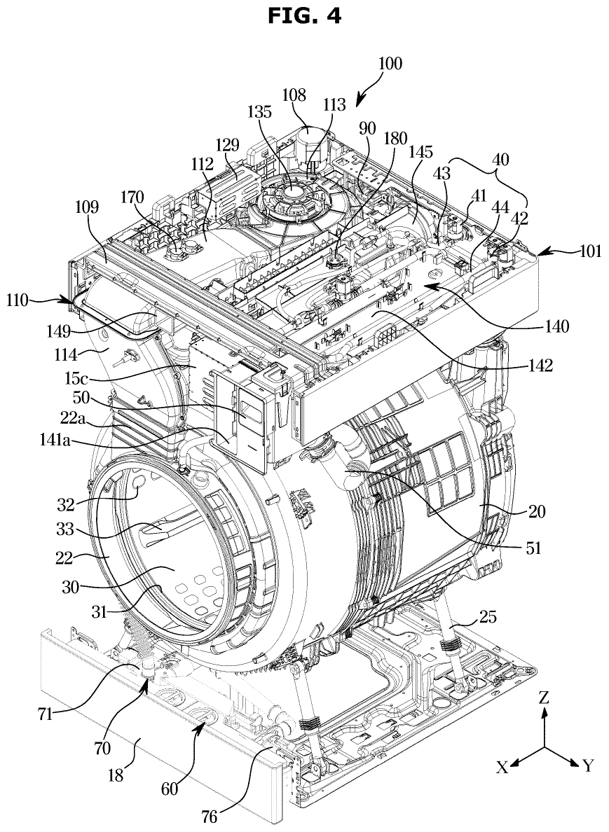

FIG. 4 illustrates some components arranged inside the clothes treating apparatus according to an embodiment of the disclosure.

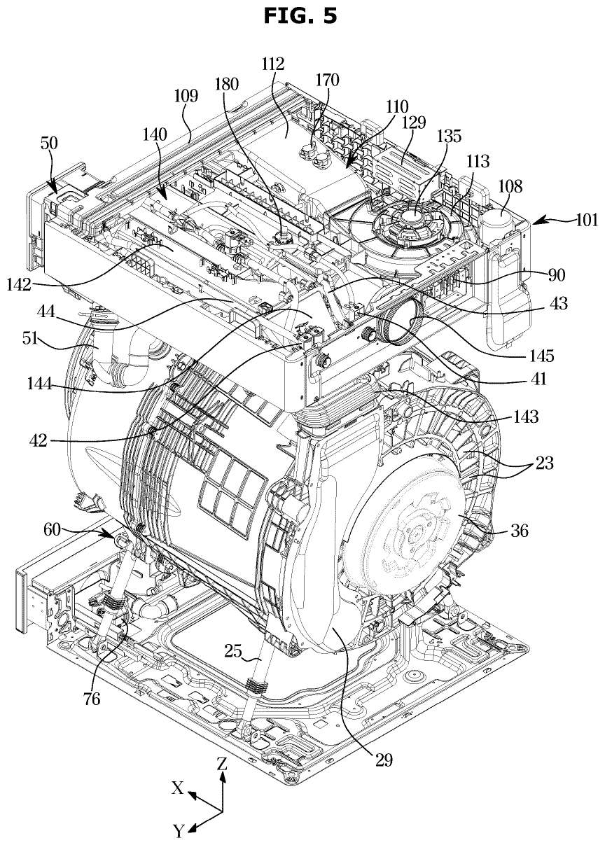

FIG. 5 illustrates some components arranged inside the clothes treating apparatus viewed from a direction different from the direction illustrated in FIG. 4 according to an embodiment of the disclosure.

Referring to FIGS. 1 to 5, a clothes treating apparatus 1 according to various embodiments may include a housing 10 provided to accommodate various components therein. The housing 10 may be formed in a box shape with a laundry inlet 11 formed on one side. The laundry inlet 11 may be provided so as to face substantially forward.

The clothes treating apparatus 1 may include a laundry door 17 for opening and closing the laundry inlet 11. The laundry door 17 may be rotatably mounted to the housing 10 by a hinge. At least a portion of the laundry door 17 may be provided to be transparent or translucent to allow the inside of the housing 10 to be visible. For example, the laundry door 17 may include tempered glass.

The clothes treating apparatus 1 may include a lower door 18 configured to provide access to a lower detergent supply device 60. The clothes treating apparatus 1 may include an upper door 19 configured to provide access to an upper detergent supply device 50 and a discharge filter 150.

The clothes treating apparatus 1 may include a tub 20 disposed inside the housing 10 to store water. The tub 20 may be formed in a substantially cylindrical shape with a tub opening 21 formed on one side, and may be arranged inside the housing 10 to allow the tub opening 21 to correspond to the laundry inlet 11. The tub opening 21 may be disposed to face substantially forward.

The tub 20 may be connected to the housing 10 by a damper 25. The damper 25 may absorb a vibration, which is generated when the drum 30 rotates, and attenuate the vibration transmitted to the housing 10.

The clothes treating apparatus 1 may include a diaphragm 22 for connecting the tub 20 and the housing 10. For example, the diaphragm 22 may extend between the laundry inlet 11 of the housing 10 and the tub opening 21 of the tub 20. The diaphragm 22 may be detachably mounted to the tub opening 21 of the tub 20. The diaphragm 22 may reduce transmission of vibration of the tub 20 to the housing 10. For example, the diaphragm 22 may include a material more flexible than a material of the housing 10 and the tub 20.

The clothes treating apparatus 1 may include a drum 30 provided to accommodate laundry. At least one lifter 33 may be provided inside the drum 30 to perform washing by raising and falling the laundry.

The drum 30 may be disposed inside the tub 20 to allow a drum opening 31, which is disposed on one side, to correspond to the laundry inlet 11 and the tub opening 21. Laundry may be accommodated inside the drum 30 or taken out from the drum 30 by passing through the laundry inlet 11, the diaphragm 22, the tub opening 21 and the drum opening 31 in sequence. The drum opening 31 may be disposed to face substantially forward.

The drum 30 may perform each operation according to washing, rinsing, and/or spin-drying processes while rotating inside the tub 20. A plurality of through-holes 32 may be formed in a cylindrical wall of the drum 30 to allow water stored in the tub 20 to flow into the inside of the drum 30 or flow out to the outside of the drum 30.

The clothes treating apparatus 1 may include a driving device 36 configured to rotate the drum 30. The driving device 36 may include a driving motor and a rotating shaft for transmitting a driving force generated by the driving motor to the drum 30. The rotating shaft may pass through the tub 20 and be connected to the drum 30.

The driving device 36 may rotate the drum 30 forward or backward to perform each operation according to the washing, rinsing, and/or spin-drying, or drying process.

The clothes treating apparatus 1 may include a water supply device 40 configured to supply water to the tub 20. The water supply device 40 may include water supply valves 41 and 42 provided to be connected to an external water source. For example, the water supply valves 41 and 42 may include a first water valve 41 and a second water valve 42. For example, the water supply valves 41 and 42 may include a hot water valve 41 for supplying hot water and a cold water valve 42 for supplying cold water.

The water supply device 40 may include water supply pipes 43 and 44. The water supply pipe 43 and 44 may be connected to the water supply valves 41 and 42. For example, the water supply pipe 43 and 44 may include a first water supply pipe 43 and a second water supply pipe 44. For example, the water supply pipes 43 and 44 may be provided as a hose or pipe formed of a flexible material.

For example, the water supply pipes 43 and 44 may include a hot water pipe 43 connected to the hot water valve 41 and a cold water pipe 44 connected to the cold water valve 42. At least one of the water supply pipes 43 or 44 may guide water from the water supply valves 41 and 42 to the tub 20. At least one of the water supply pipes 43 or 44 may extend from a water supply valve 62 to the tub 20. Water may be supplied to the lower detergent supply device 60 by passing through the tub 20. Water may also be supplied to the lower detergent supply device 60 without passing through the tub 20.

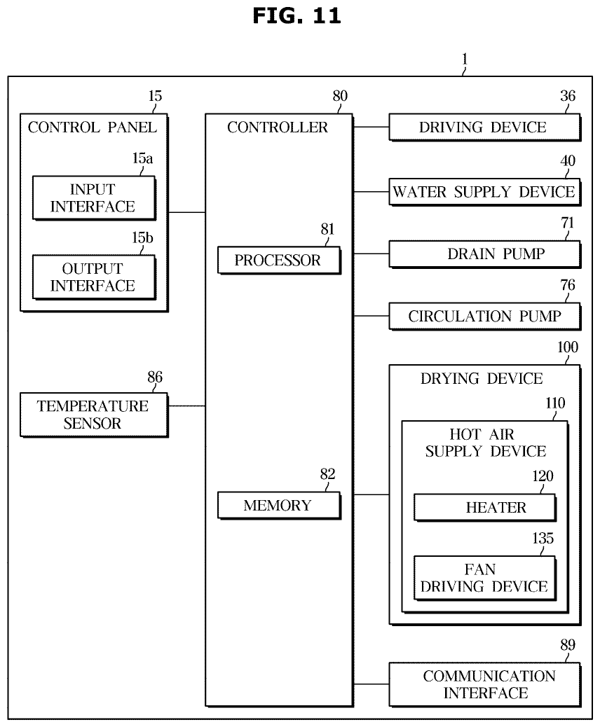

The water supply valves 41 and 42 may open or close the water supply pipes 43 and 44 in response to an electrical signal from a controller 80 (refer to FIG. 11). The water supply valves 41 and 42 may allow or block the supply of water from an external water source to the tub 20. The water supply valves 41 and 42 may be a solenoid valve configured to open and close in response to an electrical signal.

The clothes treating apparatus 1 may include the detergent supply devices 50 and 60 configured to supply detergent to the tub 20. The detergent supply devices 50 and 60 may include the upper detergent supply device 50 and the lower detergent supply device 60. The detergent may be used as a term encompassing pre-wash detergent, main wash detergent, fabric softener, bleach, and the like.

The upper detergent supply device 50 may be disposed in an upper portion of the tub 20. The upper detergent supply device 50 may be disposed above the tub 20 with respect to the up and down direction. The upper detergent supply device 50 may include a manual detergent supply device that requires a user to add detergent to be used for each wash, or an automatic detergent supply device that stores a large amount of detergent and automatically adds a defined amount of detergent during the wash. The upper detergent supply device 50 may be connected to the tub 20 through a detergent connection pipe 51. For example, the upper detergent supply device 50 may be configured to supply solid detergent and/or fabric softener to the tub 20. However, the type of detergent is not limited to the above-described example.

The lower detergent supply device 60 may be disposed in a lower portion of the tub 20. The lower detergent supply device 60 may be disposed under the tub 20 with respect to the up and down direction. The lower detergent supply device 60 may include a manual detergent supply device that requires a user to add detergent to be used for each wash, or an automatic detergent supply device that stores a large amount of detergent and automatically adds a defined amount of detergent during the wash. For example, the lower detergent supply device 60 may be configured to supply liquid detergent and/or fabric softener to the tub 20. However, the type of detergent is not limited to the above-described example.

The clothes treating apparatus 1 may include a drainage device 70 configured to discharge water contained in the tub 20 to the outside. The drainage device 70 may include a drain pump 71 for discharging water in the tub 20 to the outside of the housing 10.

The clothes treating apparatus 1 may include a circulation pump 76 for circulating water of the tub 20 to the tub 20 through the lower detergent supply device 60.

The drainage device 70 may be connected to the tub 20 through a tub connection pipe 72. The drainage device 70 may discharge water of the tub 20 to the outside of the housing 10 through a drain pipe 73.

The clothes treating apparatus 1 according to an embodiment of the disclosure may include a wash water heater 24. The wash water heater 24 may be provided below the tub 20 to heat wash water during a washing operation. In addition, the water supply device 40 may supply a defined amount of water to the lower side of the tub 20 through a connection flow path P during a drying operation, and the wash water heater 24 may generate steam by heating water supplied to the inside of the tub 20 through the water supply device 40, the connection flow path P, and a tub exhaust port 27. That is, steam generated by the water supply device 40 and the wash water heater 24 may contact clothes during the drying operation, thereby reducing generation of wrinkles on the clothes.

That is, the clothes treating apparatus 1 according to an embodiment of the disclosure is a washer-dryer combination that, unlike conventional dryers, may include the wash water heater 24 for heating wash water, and may prevent wrinkles from forming on clothes during the drying operation as much as possible by generating steam using the wash water heater 24 and the water supply device 40 for cleaning the connection flow path P.

The clothes treating apparatus 1 may include a control panel 15 arranged on one side of the housing 10. The control panel 15 may provide a user interface for interaction between a user and the clothes treating apparatus 1. The user interface may include at least one input interface and at least one output interface.

The at least one input interface may convert sensory information received from a user into an electrical signal.

The at least one input interface may include a power button, an operation button, a course selection dial (or a course selection button), and a washing/rinsing/spin-drying setting button. The at least one input interface may include a tact switch, a push switch, a slide switch, a toggle switch, a micro switch, a touch switch, a touch pad, a touch screen, a jog dial, and/or a microphone.

The at least one output interface may visually or audibly convey information related to the operation of the clothes treating apparatus 1 to a user.

For example, the at least one output interface may convey information related to a washing course and an operating time of the clothes treating apparatus 1, and washing settings/rinsing settings/spin-drying settings to a user. The information related to the operation of the clothes treating apparatus may be output by a screen, an indicator, a voice, etc. The at least one output interface may include a liquid crystal display (LCD) panel, a light emitting diode (LED) panel, a speaker, etc.

The clothes treating apparatus 1 may include a control box 15c for the control panel 15. The control box 15c for the control panel 15 may be electrically connected to the control panel 15. The control box 15c for the control panel 15 may supply power to the control panel 15. The control box 15c for the control panel 15 may process information input through the control panel 15. The control box 15c for the control panel 15 may control the control panel 15 to output information through the control panel 15.

The clothes treating apparatus 1 may include a drying device 100 for drying laundry accommodated inside the drum 30. The drying device 100 may be configured to heat air and supply the heated air into the tub 20. The drying device 100 may discharge air discharged from the tub 20 to the outside of the clothes treating apparatus 1. The clothes treating apparatus 1 may be configured to draw in outside air, heat the air, and supply the heated air to the tub 20 to dry clothes inside the drum 30, and discharge air discharged from the tub 20 after drying the clothes inside the drum 30 to the outside of the clothes treating apparatus 1. The drying device 100 according to various embodiments may be disposed in an upper portion of the tub 20.

The clothes treating apparatus 1 may include a terminal module 90. The terminal module 90 may include a terminal block. For example, the clothes treating apparatus 1 including a drying function uses relatively high voltage, and may smoothly supply power through the terminal module 90.

The clothes treating apparatus 1 may include a terminal cover 91 for covering the terminal module 90. The terminal cover 91 may be detachably coupled to the housing 10. For example, the terminal module 90 may be provided in the drying device 100, and the terminal cover 91 may be detachably mounted to the drying device 100.

The clothes treating apparatus 1 may include a connector coupling portion 149 for coupling a connector for electrically connecting the terminal module 90 and the control panel 15. For example, a connector provided on a wire extending from the terminal module 90 may be connected to a connector provided on a wire extending from the control panel 15 at the connector coupling portion 149. The connector coupling portion 149 may include a space for coupling a connector provided on a wire extending from the terminal module 90 and a wire extending from the control panel 15. For example, the connector coupling portion 149 may be provided in the drying device 100. For example, the connector coupling portion 149 may be provided in a discharge cover 142 of a discharge device 140 of the drying device 100.

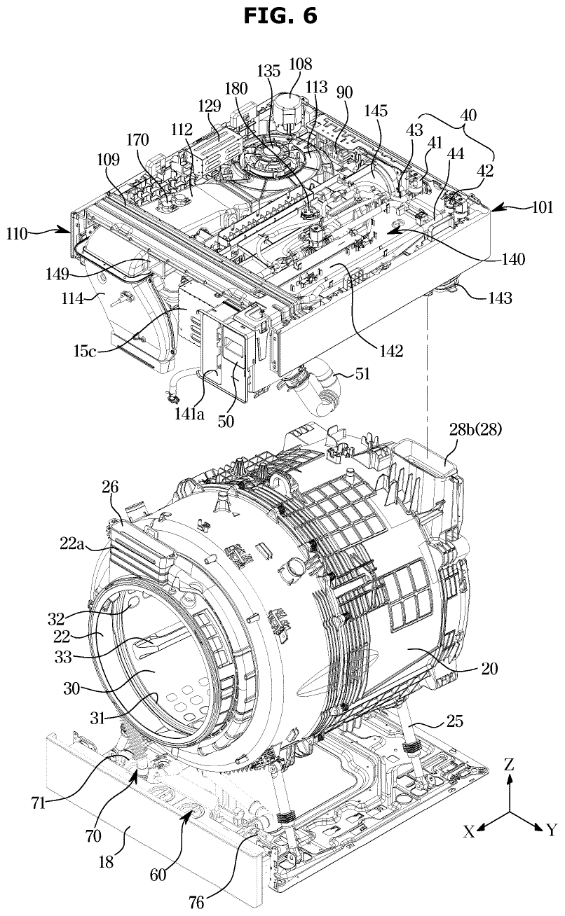

FIG. 6 illustrates a state in which a drying device of the clothes treating apparatus is disassembled from a tub according to an embodiment of the disclosure.

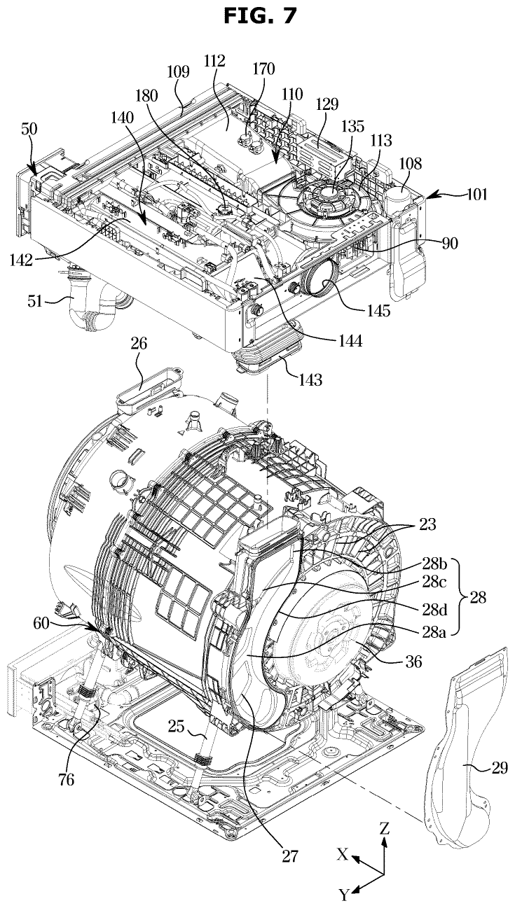

FIG. 7 illustrates a state in which the drying device of the clothes treating apparatus is disassembled from the tub viewed from a direction different from the direction illustrated in FIG. 6 according to an embodiment of the disclosure.

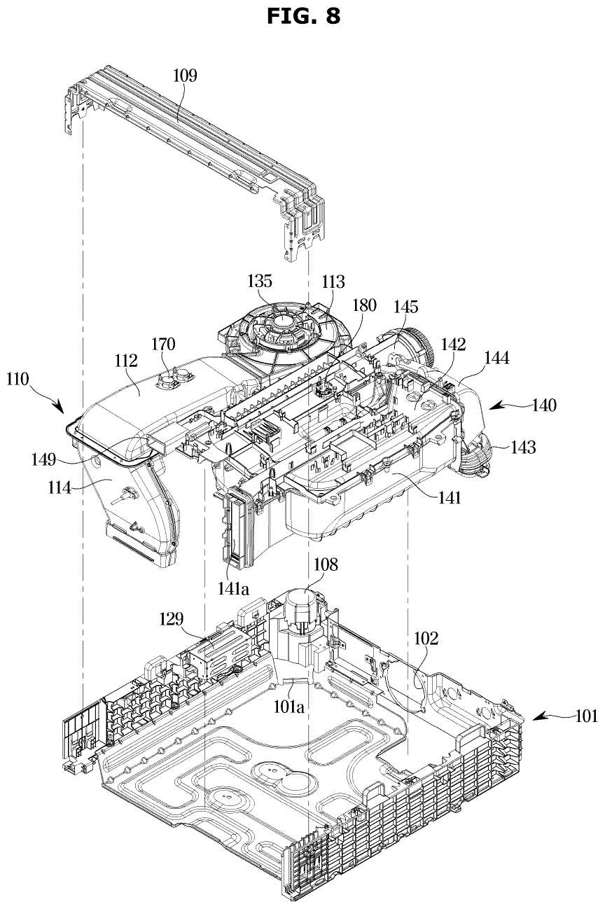

FIG. 8 illustrates a state in which a hot air supply device and a discharge device of a drying device of the clothes treating apparatus are disassembled from a drying case according to an embodiment of the disclosure.

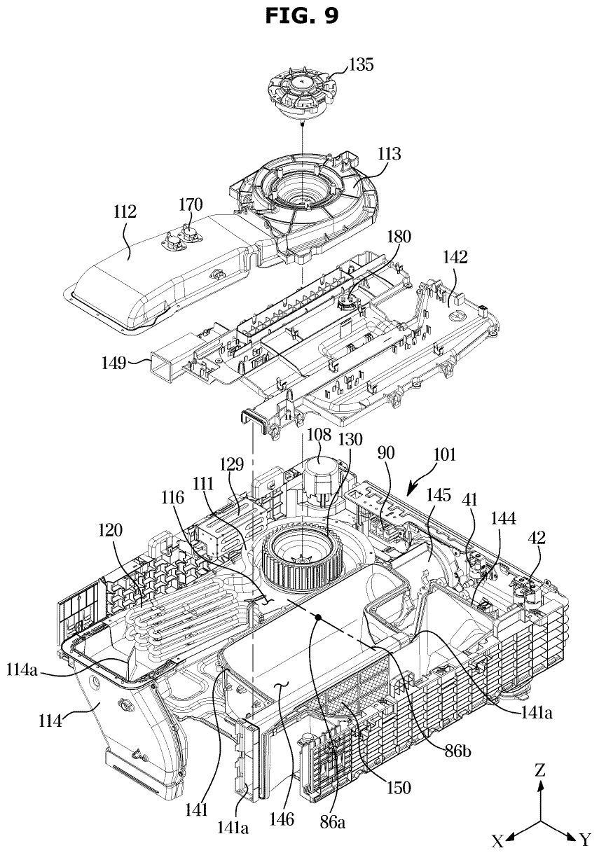

FIG. 9 illustrates the interior of the hot air supply device and the discharge device by disassembling some components of the drying device of the clothes treating apparatus according to an embodiment of the disclosure.

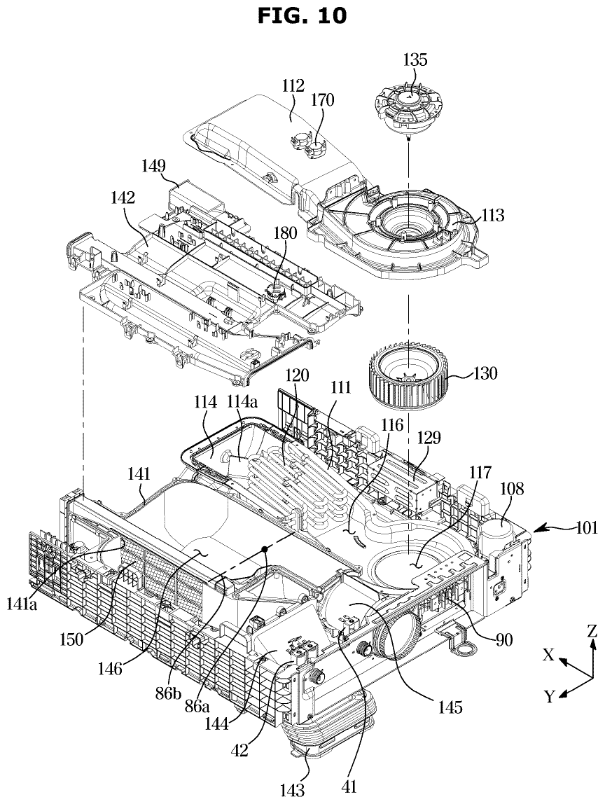

FIG. 10 illustrates the interior of the hot air supply device and the discharge device by disassembling some components of the drying device of the clothes treating apparatus viewed from a direction different from the direction illustrated in FIG. 9 according to an embodiment of the disclosure.

Referring to FIGS. 4 to 10, the drying device 100 may include a drying case 101. Various components of the drying device 100 may be installed in the drying case 101. For example, a hot air supply device 110 and/or a discharge device 140 of the drying device 100 may be installed in the drying case 101. The drying device 100 may be provided as a single module with the hot air supply device 110 and the discharge device 140 installed in the drying case 101.

Referring to FIG. 8, the drying case 101 may include a case opening 101a for air introduced into the housing 10 to flow into the drying device 100. For example, the case opening 101a may include at least one opening. For example, the case opening 101a may be provided on a side portion of the drying case 101 adjacent to the fan 130.

Referring to FIG. 8, the drying case 101 may include a guide mounting portion 102 for discharging air inside the drying device 100 to the outside of the drying device 100. As a portion of the discharge device 140 is mounted to the guide mounting portion 102, air inside the drying device 100 may be discharged to the outside of the drying device 100. For example, the guide mounting portion 102 may be provided on a rear side of the drying case 101.

The drying device 100 may include a reinforcing frame 109 for reinforcing the rigidity of the drying case 101. For example, the reinforcing frame 109 may be detachably mounted to a front end of the drying case 101. For example, the reinforcing frame 109 may be mounted to the drying case 101 in a state where the hot air supply device 110 and the discharge device 140 are mounted to the drying case 101. For example, the hot air supply device 110 and the discharge device 140 may be separated from the drying case 101 in a state where the reinforcing frame 109 is separated from the drying case 101.

The drying device 100 may include a hot air supply device 110 for supplying hot air, that is, heated air, to the tub 20. The hot air supply device 110 may be mounted to the drying case 101. A supply flow path 116 through which air to be supplied to the tub 20 flows may be formed inside the hot air supply device 110.

For example, the hot air supply device 110 may be connected to the diaphragm 22. An end of the hot air supply device 110 from which air is discharged may be connected to the diaphragm 22. The diaphragm 22 may include a diaphragm connection portion 22a connected to the end of the hot air supply device 110. An air inlet 26 may be provided in the diaphragm connection portion 22a. Air discharged from the hot air supply device 110 may be supplied to the inside of the drum 30 through the air inlet 26.

The hot air supply device 110 may be configured to guide air introduced into the housing 10 to the tub 20. The hot air supply device 110 may be configured to heat air introduced into the housing 10. The hot air supply device 110 may be configured to convert outside air introduced into the housing 10 into high-temperature dry air.

For example, referring to FIG. 2, an outside air hole 10a through which outside air is introduced may be formed on a rear surface of the housing 10, and as the hot air supply device 110 operates, outside air may be introduced into the housing 10 through the outside air hole 10a. Referring to FIG. 8, air introduced into the housing 10 may be introduced into the drying device 100 through at least one case opening 101a formed in the drying case 101. Air introduced into the drying device 100 may be introduced into the hot air supply device 110.

The hot air supply device 110 may include a supply base 111. The supply base 111 may be mounted to the drying case 101. The supply base 111 may form a portion of the supply flow path 116. Components of the hot air supply device 110 may be accommodated in the supply base 111. The supply base 111 may form at least a portion of the supply flow path 116. For example, the supply base 111 may have a shape with an open upper side.

The hot air supply device 110 may include a supply cover 112. The supply cover 112 may be coupled to the supply base 111. The supply cover 112 may cover an open portion of the supply base 111. The supply cover 112 may form at least a portion of the supply flow path 116 together with the supply base 111. For example, as the supply cover 112 is coupled to the supply base 111, at least a portion of the supply flow path 116 may be formed.

The hot air supply device 110 may include a heater 120 for heating air passing through the hot air supply device 110. The heater 120 may heat air flowing through the supply flow path 116. For example, the heater 120 may include a dual heater.

The drying device 100 may include a heater control box 129 for controlling the heater 120. The heater control box 129 may be electrically connected to the heater 120. For example, the heater control box 129 may be mounted to the drying case 101.

The hot air supply device 110 may include a fan 130 for forming an air flow inside the hot air supply device 110. The fan 130 may be configured to draw in air from outside the housing 10 and blow the air to the tub 20. The fan 130 may be configured to supply air to an object inside the drum 30. For example, the fan 130 may include a sirocco fan. For example, the fan 130 may be configured to draw in air in an axial direction of the fan 130 and discharge the air outward in a circumferential direction of the fan 130.

The hot air supply device 110 may include a fan driving device 135 for providing power to the fan 130. For example, the hot air supply device 110 may include a fan cover 113 couplable to the supply base 111 and/or the supply cover 112. The fan driving device 135 may be mounted to the fan cover 113.

Referring to FIG. 10, the supply base 111 may include a supply inlet 117 through which air is introduced into the hot air supply device 110. The supply inlet 117 may be formed to penetrate the supply base 111 in an axial direction of the fan 130. As the fan 130 operates, air outside the hot air supply device 110 may be introduced into the hot air supply device 110 through the supply inlet 117.

The hot air supply device 110 may include a supply connection part 114 for connection to the tub 20. The supply connection part 114 may be connected to a front end of the tub 20. For example, the supply base 111 may extend in a front-rear direction, and the supply connection part 114 may extend in an up-down direction.

The supply connection part 114 may include a supply guide portion 114a for guiding air flowing from the supply base 111 to the supply connection part 114. The supply guide portion 114a may have a rib shape. The supply guide portion 114a may be configured to agitate dry air supplied to the tub 20 so as to reduce temperature deviation of the dry air supplied to the tub 20.

For example, the supply connection part 114 may be positioned at an end opposite to one end of the supply base 111 where the fan 130 is located. For example, the supply connection part 114 may be connected to an end opposite to one end of the supply base 111 where the supply inlet 117 is formed. As the supply connection part 114 and the supply inlet 117 are spaced apart from each other at both ends of the supply base 111, air introduced through the supply inlet 117 may have time to be heated by the heater 120 before being supplied to the tub 20 through the supply connection part 114.

The supply connection part 114 of the hot air supply device 110 may be connected to the air inlet 26. The air inlet 26 of the tub 20 may be provided in the diaphragm 22 provided at a front end of the tub 20. The supply connection part 114 may be connected to a diaphragm connection portion 22a provided in the diaphragm 22. For example, the supply connection part 114 and the diaphragm connection portion 22a may be configured to be fixed by mounting a clamp to a portion where the supply connection part 114 and the diaphragm connection portion 22a are coupled.

The drying device 100 may include a thermostat 170 configured to stop the operation of the drying device 100 based on a temperature of dry air supplied through the hot air supply device 110 exceeding a defined temperature. For example, the thermostat 170 may be mounted to the hot air supply device 110. For example, the thermostat 170 may include a sensor for detecting a temperature of the supply flow path 116.

Referring to FIGS. 3 to 7, heated air in the drying device 100 may be supplied to the inside of the drum 30 through the tub 20. To secure time for the heated air supplied to the inside of the drum 30 to remove moisture from laundry, the tub exhaust port 27 may be provided at a position opposite to the air inlet 26 where the heated air from the drying device 100 is supplied to the tub 20. To increase a distance and/or time that the heated air flows inside the drum 30 such that it can contact the laundry more, the tub exhaust port 27 may be provided at a position opposite to the air inlet 26 where the heated air from the drying device 100 is supplied to the tub 20. By increasing the time that the heated air and the laundry are in contact, drying efficiency can be improved.

The air inlet 26 and the tub exhaust port 27 according to an embodiment of the disclosure may be arranged to maximize utilization of heated air provided from the drying device 100. For example, the air inlet 26 may be positioned at a front end of the tub 20, and the tub exhaust port 27 may be positioned at a rear end of the tub 20.

The clothes treating apparatus 1 according to various embodiments may include a connection flow path P through which air discharged from the inside of the tub 20 flows to the drying device 100. The connection flow path P may be configured to allow air discharged from the tub exhaust port 27 to flow to a discharge flow path 146 of the drying device 100. The connection flow path P may be configured to discharge humid air that has passed through the tub 20. For example, the connection flow path P may be provided at a rear of the tub 20.

Air inside the tub 20 may be discharged to a tub duct 28 through the tub exhaust port 27 formed on a rear surface of the tub 20. Air discharged to the tub duct 28 may flow along the connection flow path P and be supplied to the drying device 100.

The clothes treating apparatus 1 according to various embodiments may include the tub duct 28 for forming at least a portion of the connection flow path P. For example, the tub duct 28 may be formed integrally with the tub 20. For example, the tub 20 may include the tub duct 28. The tub duct 28 may be configured to surround the tub exhaust port 27.

The clothes treating apparatus 1 according to various embodiments may include a duct cover 29 for forming at least a portion of the connection flow path P. The duct cover 29 may be configured to cover an open rear surface of the tub duct 28. For example, the tub 20 may include the duct cover 29. The duct cover 29 may form at least a portion of the connection flow path P through which air discharged through the tub exhaust port 27 flows to the drying device 100.

In the clothes treating apparatus 1 according to various embodiments, the connection flow path P may be formed as the duct cover 29 is coupled to the tub duct 28.

The tub duct 28 according to an embodiment may include a recess portion 28a forming a part of the connection flow path P through which air discharged from the inside of the tub 20 flows. A reinforcing rib 23 for reinforcing the rigidity of the tub 20 may be provided on a rear surface of the tub 20, and the recess portion 28a may be provided as a portion recessed from an end of the reinforcing rib 23 protruding from the rear surface of the tub 20. The recess portion 28a may be provided as a portion where the reinforcing rib 23 is not formed on the rear surface of the tub 20. The tub exhaust port 27 through which air is discharged from the inside of the tub 20 may be formed in the recess portion 28a. The tub duct 28 may include a partition rib 28d provided along a periphery of the recess portion 28a. The partition rib 28d may distinguish between a region where the reinforcing rib 23 is formed and a region where the recess portion 28a is formed on the rear surface of the tub 20.

The tub duct 28 according to an embodiment may include a duct connection portion 28b forming another part of the connection flow path P through which air that has passed through the recess portion 28a flows. The duct connection portion 28b may protrude outward from an outer circumferential surface of the tub 20. The duct connection portion 28b may protrude approximately upward from the outer circumferential surface of the tub 20.

The duct connection portion 28b may allow communication between the drying device 100 and the recess portion 28a. The duct connection portion 28b may be connected to a discharge connection part 143 of the drying device 100. The duct connection portion 28b may form a single passage constituting the connection flow path P together with the recess portion 28a and the duct cover 29.

The duct connection portion 28b may be covered by the duct cover 29. The duct connection portion 28b may have one side open. The duct cover 29 may cover the open one side of the duct connection portion 28b.

The duct cover 29 may cover both the recess portion 28a and the duct connection portion 28b. For example, the duct cover 29 may cover both the open one side of the recess portion 28a and the open one side of the duct connection portion 28b. The connection flow path P may be formed by the duct cover 29 that covers the recess portion 28a and the duct connection portion 28b. For example, the duct cover 29 may cover only the recess portion 28a.

The duct cover 29 may be configured to cover the open rear surface of the recess portion 28a and/or the open rear surface of the duct connection portion 28b. The connection flow path P may be a single passage formed by the tub duct 28 and the duct cover 29 together.

The tub duct 28 may include a stepped portion 28c for expanding a cross-sectional area of the connection flow path P. The connection flow path P may be configured to have a width of a portion formed by the duct connection portion 28b larger than a width of a portion formed in the recess portion 28a by the stepped portion 28c.

The drying device 100 may include the discharge device 140 for discharging air discharged from the tub 20 to the outside of the clothes treating apparatus 1. The discharge device 140 may be mounted to the drying case 101. The discharge device 140 may be configured to form a discharge flow path 146 for discharging air discharged from the tub 20 to the outside of the housing 10.

The discharge device 140 may include a discharge base 141. The discharge base 141 may be mounted to the drying case 101. The discharge base 141 may form at least a portion of the discharge flow path 146. The discharge base 141 may be configured to have the discharge flow path 146 formed in approximately a U-shape.

The discharge device 140 may include a discharge cover 142. The discharge cover 142 may be coupled to the discharge base 141. The discharge cover 142 may form at least a portion of the discharge flow path 146. The discharge cover 142 may cover an open portion of the discharge base 141. The discharge cover 142 may form at least a portion of the discharge flow path 146 together with the discharge base 141. For example, as the discharge cover 142 is coupled to the discharge base 141, at least a portion of the discharge flow path 146 may be formed.

The discharge device 140 may include a discharge connection part 143 connected to the tub 20. The discharge connection part 143 may guide air discharged from the tub 20 and passed through the connection flow path P. A flow path through which air flows may be formed inside the discharge connection part 143. The discharge connection part 143 may be connected to the duct connection portion 28b of the tub 20.

For example, the discharge connection part 143 may include a flexible material. For example, the discharge connection part 143 may have a structure with a changeable length. For example, the discharge connection part 143 may include a material having elasticity. For example, the discharge connection part 143 may include a material having stretchability. The discharge connection part 143 may be configured to reduce transmission of vibration from the tub 20 to the drying device 100. The discharge connection part 143 may seal between the duct connection portion 28b of the tub 20 and a duct guide 144 of the discharge device 140.

The discharge device 140 may include the duct guide 144 connected to the discharge connection part 143. The duct guide 144 may be configured to guide air that has passed through the discharge connection part 143 to the discharge flow path 146. The duct guide 144 may connect the discharge connection part 143 to the discharge base 141 and/or the discharge cover 142. The duct guide 144 may be configured to change a flow direction of air that is discharged from the tub 20 and flows upward along the connection flow path P. The duct guide 144 may include a material having higher strength than the discharge connection part 143.

The discharge device 140 may include a discharge guide 145 for guiding air that has passed through the discharge base 141 to the outside of the housing 10. The discharge guide 145 may be connected to the discharge base 141. The discharge guide 145 may be mounted to a guide mounting portion 102 formed in the drying case 101. The guide mounting portion 102 may be positioned at a rear end of the drying case 101.

The discharge guide 145 may be positioned approximately at a center of the rear end of the drying device 100. For example, water supply valves 41 and 42 may be positioned on one side of the discharge guide 145, and a terminal module 90 may be positioned on an opposite side to the one side where the water supply valves 41 and 42 are positioned. The discharge guide 145 may be positioned between the water supply valves 41 and 42 and the terminal module 90 at the rear end of the drying device 100.

The drying device 100 may include a discharge filter 150 detachably couplable to the discharge device 140. The discharge filter 150 may filter foreign substances from air passing through the discharge device 140. The discharge filter 150 may filter foreign substances from air passing through the discharge flow path 146. The discharge filter 150 may be detachably mounted to the discharge base 141 and/or the discharge cover 142. The discharge filter 150 may be configured to be accessible by opening the upper door 19 shown in FIG. 1.

A filter mounting portion 141a for mounting the discharge filter 150 may be provided in the discharge base 141. The filter mounting portion 141a may extend from a front end of the discharge base 141 toward a rear. The filter mounting portion 141a may be configured to correspond to a size and/or shape of the discharge filter 150. The filter mounting portion 141a may include a rail on which the discharge filter 150 is slidably movable. The discharge filter 150 may be mounted to the filter mounting portion 141a with sliding movement.

In the clothes treating apparatus 1 according to an embodiment of the disclosure, because the discharge filter 150 for filtering foreign substances from humid air discharged from the tub 20 is provided in the drying device 100 positioned above the tub 20, a user or an operator can easily access the filter for maintenance and/or repair.

The drying device 100 may include a humidity sensor 180 for detecting humidity discharged through the discharge device 140. The humidity sensor 180 may be configured to detect humidity of air passing through the discharge flow path 146. For example, the humidity sensor 180 may be mounted to the discharge device 140.

In an embodiment, to prevent damage to the humidity sensor 180, the humidity sensor 180 may be provided on a downstream side of the discharge filter 150 on the discharge flow path 146. Through this, air flowing from the tub 20 to the discharge device 140 may reach the humidity sensor 180 via the discharge filter 150.

According to various embodiments, the humidity sensor 180 may be accommodated in a sensor housing 180h. A sensor filter 180f may be formed in at least a portion of the sensor housing 180h. The sensor filter 180f may filter foreign substances from air passing through the humidity sensor 180. Air flowing from the tub 20 to the discharge device 140 may reach the humidity sensor 180 via the sensor filter 180f formed in the sensor housing 180h.

As such, the clothes treating apparatus 1 may include at least one filter (e.g., the discharge filter 150 and/or the sensor filter 180f) for filtering foreign substances in air flowing along the discharge flow path 146.

According to an embodiment of the disclosure, because air flowing along the discharge flow path 146 is filtered at least once by at least one filter (e.g., the discharge filter 150 and/or the sensor filter 180f) before reaching the humidity sensor 180, damage to the humidity sensor 180 by foreign substances contained in the air may be prevented.

The humidity of air passing through the discharge flow path 146 may correspond to the humidity of laundry. For example, when the humidity of laundry is high, the humidity of air passing through the discharge flow path 146 also increases, and when the humidity of laundry is low, the humidity of air passing through the discharge flow path 146 also decreases.

According to the disclosure, instead of providing a humidity sensor in the form of an electrode sensor inside the drum as used in conventional dryers, the humidity sensor 180 is provided in the discharge flow path 146, thereby allowing the clothes treating apparatus 1 to perform a washing course, in which water is introduced into the drum, along with a drying course.

The drying device 100 may include an electromagnetic interference filter (EMI) filter 108. The EMI filter 108 may be configured to reduce or block electromagnetic interference of the clothes treating apparatus 1. The EMI filter 108 may be mounted to the drying case 101. For example, the EMI filter 108 may be positioned at a rear of the hot air supply device 110. For example, the EMI filter 108 may be positioned at a corner portion of the drying case 101.

In the clothes treating apparatus 1 according to an embodiment of the disclosure, because the drying heater 120 is provided in the hot air supply device 110 and the discharge filter 150 is provided in the discharge device 140, damage to the discharge filter 150 by the drying heater 120 may be reduced.

In the clothes treating apparatus 1 according to an embodiment of the disclosure, because the heater 120 is provided in the hot air supply device 110 and the discharge filter 150 is provided in the discharge device 140, damage to the discharge filter 150 by the heater 120 may be reduced.

Referring to FIG. 8, the clothes treating apparatus 1 according to an embodiment of the disclosure may be configured to allow the hot air supply device 110 and the discharge device 140 to be separated from the drying case 101 respectively. The hot air supply device 110 and the discharge device 140 may be provided as separate components.

FIG. 11 is a control block diagram of the clothes treating apparatus according to an embodiment of the disclosure.

Referring to FIG. 11, the clothes treating apparatus 1 may include a controller 80. The controller 80 may be electrically connected to various components and/or devices of the clothes treating apparatus 1 and may control various components and/or devices.

For example, the controller 80 may control the control panel 15, the driving device 36, the water supply device 40, the drain pump 71, the circulation pump 76, the drying device 100, and a communication interface 89. The controller 80 may be electrically connected to the temperature sensor 86.

The controller 80 may include a processor 81 and memory 82. The memory 82 may include a volatile memory (e.g., Static Random Access Memory (S-RAM) and Dynamic Random Access Memory (D-RAM)) and a non-volatile memory (e.g., Read Only Memory (ROM), and Erasable Programmable Read Only Memory (EPROM)). The processor 81 and the memory 82 may be implemented as separate chips or as a single chip. In addition, a plurality of processors and a plurality of memories may be provided. The processor 81 may process various data and various signals using instructions, data, programs, and/or software stored in the memory 82. The processor 81 may include one core or a plurality of cores. The processor 81 may generate a control signal for controlling elements of the clothes treating apparatus 1.

The control panel 15 may obtain various user inputs and output various information regarding the operation of the clothes treating apparatus 1. The control panel 15 may include an input interface 15a and an output interface 15b.

The input interface 15a may convert sensory information received from a user into an electrical signal. For example, the input interface 15a may include a power button, an operation button, a course selection dial (or a course selection button), and a washing/rinsing/spin-drying setting button. The input interface 15a may include a tact switch, a push switch, a slide switch, a toggle switch, a micro switch, a touch switch, a touch pad, a touch screen, a jog dial, and/or a microphone.

The output interface 15b may visually or audibly convey information related to the operation of the clothes treating apparatus 1 to a user. That is, the output interface 15b may output information related to the operation of the clothes treating apparatus 1. For example, the output interface 15b may convey information related to a washing course and an operating time of the clothes treating apparatus 1, and washing settings/rinsing settings/spin-drying settings to a user. The information related to the operation of the clothes treating apparatus may be output by a screen, an indicator, a voice, etc. The output interface 15b may include a liquid crystal display (LCD) panel, a light emitting diode (LED) panel, a speaker, etc.

The controller 80 may control the operation of the clothes treating apparatus 1 based on the user input obtained through the control panel 15. For example, the controller 80 may turn on or off the clothes treating apparatus 1 based on the user input for turning on or off the clothes treating apparatus 1. The controller 80 may determine the operation course of the clothes treating apparatus 1 based on the user input for setting the operation course of the clothes treating apparatus 1.

The operation course of the clothes treating apparatus 1 may be provided in various ways. For example, the operation courses of the clothes treating apparatus 1 may be broadly classified into a washing course, a drying course, and a heat exchanger cleaning course. In the disclosure, the washing course may be referred to as a washing operation, and the drying course may be referred to as a drying operation.

The washing course may be provided in various ways according to the type of laundry (e.g., clothes, blanket, underwear, etc.) and material (e.g., cotton, wool, nylon, etc.). For example, the washing course may include at least one of a normal course, a strong course, a delicate course, a blanket course, a baby clothes course, a towel course, a boil course, or an outdoor clothes course. Each of the plurality of washing courses may include different washing settings (e.g., washing temperature, number of rinses, spin-drying intensity, etc.). When one of the plurality of washing courses is selected through the control panel 15 or an external user device, the controller 80 may control the clothes treating apparatus 1 to perform the washing process, the rinsing process, and the spin-drying process corresponding to the selected washing course. In addition, the washing course may include the rinsing and the spin-drying course excluding the washing process, the rinsing course, and the spin-drying course. The washing course is not limited thereto.

The drying course may also be provided in various ways according to the type of a drying target (e.g., clothes, blanket, underwear, etc.) and material (e.g., cotton, wool, nylon, etc.). For example, the drying course may include at least one of normal drying, strong drying, delicate clothes drying, blanket drying, baby clothes drying, towel drying, or outdoor clothes drying. Each of the plurality of drying courses may include different drying settings (e.g., drying temperature, drying time, etc.). When one of the plurality of drying courses is selected through the control panel 15 or an external user device, the controller 80 may control the clothes treating apparatus 1 to perform a drying process corresponding to the selected drying course. The drying course is not limited thereto.

The controller 80 may control the control panel 15 to output various information regarding the operation of the clothes treating apparatus 1. For example, the control panel 15 may visually and/or audibly output information regarding the operation course, operating time, washing setting, rinsing setting, spin-drying setting, and/or drying setting of the clothes treating apparatus 1. The control panel 15 may output information regarding an abnormal condition of the clothes treating apparatus 1.

The driving device 36 may rotate the drum 30 under the control of the controller 80. The driving device 36 may include a driving motor. The controlling of the driving device 36 by the controller 80 may include controlling the driving motor by the controller 80. The controller 80 may control the driving motor to adjust a rotation speed of the drum 30. That is, the controller 80 may control the driving device 36 to adjust the rotation speed of the drum 30.

The water supply device 40 may selectively supply water to the tub 20. The water supply device 40 may include the water supply pipes 43 and 44 connected to an external water source and the water supply valves 41 and 42 for opening or closing the water supply pipes. The water supply device 40 may include the first water supply valve 41 and the second water supply valve 42. As described above, the first water supply valve 41 may correspond to the hot water valve. The second water supply valve 42 may correspond to the cold water valve. The water supply pipes 43 and 44 may include a first water supply pipe corresponding to the hot water pipe 43 and a second water supply pipe corresponding to the cold water pipe 44.

The controller 80 may control the opening and closing of each of the first water supply valve 41 and the second water supply valve 42. The controller 80 may adjust an opening degree of each of the first water supply valve 41 and the second water supply valve 42. The first water supply valve 41 may open or close the first water supply pipe based on an electrical signal transmitted from the controller 80. The second water supply valve 42 may open or close the second water supply pipe based on an electrical signal transmitted from the controller 80.

The drain pump 71 may discharge water inside the tub 20 to the outside of the housing 10. The controller 80 may control the drain pump 71 to allow the water of the tub 20 to be discharged to the outside through the drain pipe 73.

The circulation pump 76 may send water of the tub 20 to the lower detergent supply device 60. Water passing through the circulation pump 76 and the lower detergent supply device 60 may return to the tub 20. The controller 80 may control the circulation pump 76 to allow the water of the tub 20 to circulate through the lower detergent supply device 60.

The drying device 100 may heat air and supply the heated air to the tub 20. The controller 80 may operate the drying device 100 to dry laundry positioned inside the drum 30. To generate dry and heated air, the drying device 100 may include a hot air supply device 110 including a fan 130, a fan driving device 135 for driving the fan, and/or a heater 120.

The controller 80 may control the fan 130 and/or the heater 120 included in the hot air supply device 110. The heater 120 may heat air, and the fan 130 may blow air heated by the heater 120 to the tub 20.

The controller 80 may control the fan driving device 135 to operate the fan 130. Accordingly, the fan 130 may supply dry and heated air into the drum 30. The controller 80 may control the fan driving device 135 to adjust a rotation speed of the fan 130. A flow rate of air supplied into the drum 30 may vary according to the rotation speed of the fan 130.

The controller 80 may change an output of the heater 120. Accordingly, the controller 80 may adjust a temperature of air supplied into the drum 30. For example, the controller 80 may reduce an output of the heater 120 by 70% compared to a previous level.

As described above, according to various embodiments, the heater 120 may be implemented as a dual heater including a plurality of heaters that operate independently. Accordingly, the controller 80 may independently change the output of each of the plurality of heaters (for example, a first heater and a second heater). For example, the controller 80 may reduce the output of the first heater to 70% compared to a previous level and reduce the output of the second heater to 30% compared to a previous level.

The temperature sensor 86 may detect the temperature of humid air and transmit an electrical signal corresponding to the temperature of the humid air to the controller 80. In this case, the humid air may refer to the air containing moisture supplied from the objects to be washed (objects to be dried) stored in the drum 30, and may include air discharged from the tub 20. That is, the temperature sensor 86 may transmit information about the temperature of the air discharged from the tub 20 to the controller 80. The controller 80 may determine the temperature of the air discharged from the tub 20 based on the electrical signal transmitted from the temperature sensor 86. The temperature sensor 86 may be located on the discharge flow path of the discharge device 140. For example, the temperature sensor 86 may be located at the start point of the discharge flow path 146 of the discharge device 140. For example, the temperature sensor 86 may be located at the portion in which air flows from the duct guide 144 to the discharge base 141 and the discharge cover 142.

According to an embodiment, the clothes treating apparatus 1 may include a plurality of temperature sensors 86a and 86b. For example, the plurality of temperature sensors 86a and 86b may be located on the same cross-section of the discharge flow path 146. In other words, the plurality of temperature sensors 86a and 86b may be located at positions spaced the same distance from the starting point of the discharge flow path 146.

The controller 80 may control the control panel 15 to visually and/or audibly output temperature of air discharged from the tub 20. The control panel 15 may display the temperature information of air supplied to the tub 20 and/or the temperature of air discharged from the tub 20 in Celsius or Fahrenheit.

The controller 80 may determine whether a fire has occurred in the drum 30 based on the temperature of the air discharged from the tub 20, and may perform a fire extinguishing operation.

For example, the controller 80 may identify that a fire has occurred in the drum 30 based on the temperature of the air discharged from the tub 20 being equal to or higher than a defined target temperature. Accordingly, the controller 80 may perform a fire extinguishing operation. In this case, the fire extinguishing operation may include rotating the drum 30 at a defined rotational speed and supplying water into the drum 30.

According to an embodiment of the disclosure, the clothes treating apparatus 1 is configured such that the controller 80 performs fire detection and fire extinguishing operation based on the temperature value measured by the temperature sensor 86. Therefore, a fire may be detected at an early stage and extinguished immediately when it occurs, thereby preventing the spread of fire and protecting the user.

The communication interface 89 may include various communication circuitry for performing wired communication and/or wireless communication with external devices (e.g., servers, user devices, and/or other home appliances). The user devices may include various electronic devices such as a smartphone, a notebook, a laptop, a smart watch, a stationary tablet, and a speaker. A user input may be obtained through the user device as well as the control panel 15.

The communication interface 89 may include at least one of a short-range communication circuit and a long-range communication circuit. The communication interface 89 may transmit data to an external device or receive data from an external device. For example, the communication interface 89 may support cellular communication, a wireless local area network(WLAN), a home radio frequency (Home RF), infrared communication, ultra-wide band (UWB) communication, Wi-Fi, Wi-Fi direct, Bluetooth, AD-HOC, and/or Zigbee. The communication technologies supported by the communication interface 89 are not limited thereto.

The communication interface 89 may also communicate with an external device through an access point (AP). The access point may connect a local area network (LAN) to which the clothes treating apparatus 1 is connected to a wide area network (WAN) to which the server is connected. The clothes treating apparatus 1 may be connected to the server through the wide area network (WAN).

The controller 80 according to an embodiment may perform a drying operation by driving the hot air supply device 110.

The controller 80 may control the driving device 36 such that the drum 30 rotates at a defined rotational speed, and control the water supply device 40 to supply water into the drum 30, based on one of the temperatures obtained by the plurality of temperature sensors 86 being equal to or higher than a defined target temperature.

In this case, the defined rotational speed may be lower than the rotational speed of the drum 30 during a spin-drying operation.

The controller 80 may stop the operation of the hot air supply device 110 before controlling the driving device 36 and the water supply device 40, based on the temperatures obtained by one of the plurality of temperature sensors 86 being equal to or higher than a defined target temperature.

The controller 80 may control the water supply device 40 to stop supplying water into the drum 30 based on the lapse of a defined reference time.

The controller 80 may control the water supply device 40 to stop supplying water into the drum 30 based on the water level in the drum 30 reaching a threshold level.

The controller 80 may control the output interface 15b to output a guide interface related to the end of the drying operation based on one of the plurality of temperature sensors 86 being identified as abnormal during the drying operation, and may determine whether the temperature obtained by one of the plurality of temperature sensors 86 is equal to or higher than the defined target temperature based on all of the plurality of temperature sensors 86 being identified as normal.

The controller 80 may identify that the plurality of temperature sensors 86 are normal based on the difference in temperatures obtained from the plurality of temperature sensors 86 being less than a defined threshold value, and may, after a first unit time has elapsed based on the difference in temperatures obtained from the plurality of temperature sensors 86 being equal to or greater than the defined threshold value, determine whether the difference in temperatures obtained from the plurality of temperature sensors 86 is equal to or greater than the defined threshold value.

The controller 80 may identify that the plurality of temperature sensors 86 are normal based on the difference in temperatures obtained from the plurality of temperature sensors 86 being less than the defined threshold value after the first unit time has elapsed, and may identify that at least one of the plurality of temperature sensors 86 is abnormal based on the difference in temperatures obtained from the plurality of temperature sensors 86 being equal to or greater than the defined threshold value after the first unit time has elapsed.

The controller 80 may, after a second unit time has elapsed, based on the temperature obtained by one of the plurality of temperature sensors 86 being equal to or lower than a defined safety temperature, determine whether the temperature obtained by one of the plurality of temperature sensors 86 is equal to or lower than the defined safety temperature.

The controller 80 may determine that fire extinguishing inside the drum 30 has been completed based on the temperature obtained by one of the plurality of temperature sensors 86 being equal to or lower than the defined safety temperature after the second unit time has elapsed.

The controller 80 may control the fan driving device 135 to stop the rotation of the drum 30, and control the drainage device 70 to drain the water supplied into the drum 30, based on the determination that fire extinguishing inside the drum 30 has been completed.

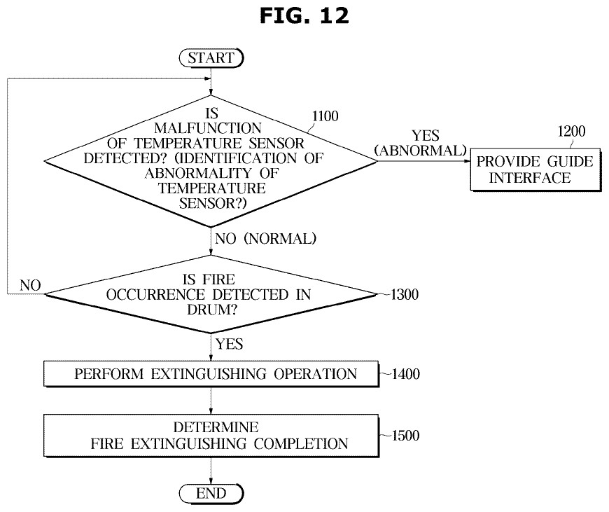

FIG. 12 is a flowchart illustrating a method of controlling a clothes treating apparatus according to an embodiment of the disclosure.

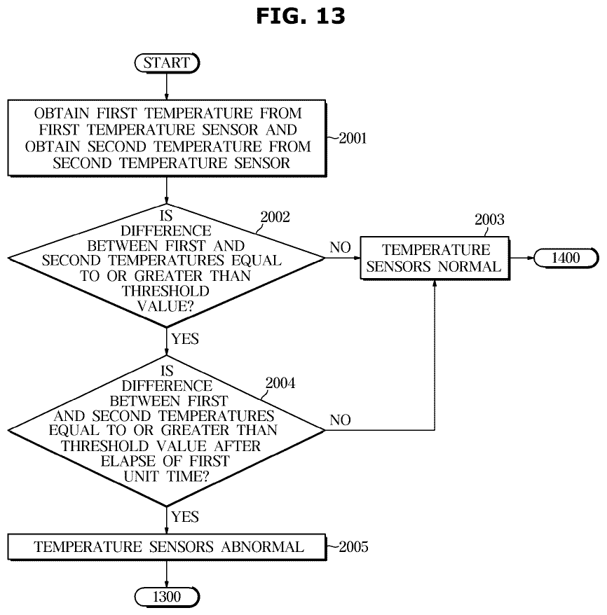

Referring to FIG. 12, the controller 80 of the clothes treating apparatus 1 may detect a malfunction of the temperature sensor in operation 1100. That is, the controller 80 may identify whether the temperature sensor is abnormal. According to an embodiment, the clothes treating apparatus 1 may include a plurality of temperature sensors 86a and 86b. The controller 80 according to an embodiment may detect a malfunction of a temperature sensor based on a temperature difference between the plurality of temperature sensors 86a and 86b. A specific method of detecting a malfunction of the temperature sensor will be described in detail with reference to FIG. 13.

According to an embodiment, the controller 80 may detect a malfunction of the temperature sensor during a drying operation. However, depending on various embodiments, the controller 80 may detect a malfunction of the temperature sensor even during an operation other than the drying operation. For example, the controller 80 may detect a malfunction of the temperature sensor even when the clothes treating apparatus 1 is not operating according to a specific course and is merely in a powered-on state.

According to an embodiment, when a malfunction of the temperature sensor is detected, that is, when the plurality of temperature sensors are identified as abnormal (YES in operation 1100), the controller 80 may provide a guide interface in operation 1200. For example, when a malfunction of the temperature sensor is detected, the controller 80 may provide a guide interface for the termination of the drying operation, since a fire occurring inside the drum 30 during the drying operation may not be detected.

In the disclosure, providing a guide interface by the controller 80 may include the controller 80 controlling the output interface 15b to output the guide interface and/or the controller 80 controlling the communication interface 89 to transmit, to an external device, a signal that allows the external device to output the guide interface.

The guide interface may include sensory information (e.g., visual information, auditory information, etc.) regarding the malfunction or abnormality of the temperature sensor.

The guide interface may include sensory information (e.g., visual information, auditory information, etc.) that guides a user on how to terminate the drying operation.

Additionally, the guide interface may include sensory information (e.g., visual information, auditory information, etc.) that induces the user to terminate the drying operation.

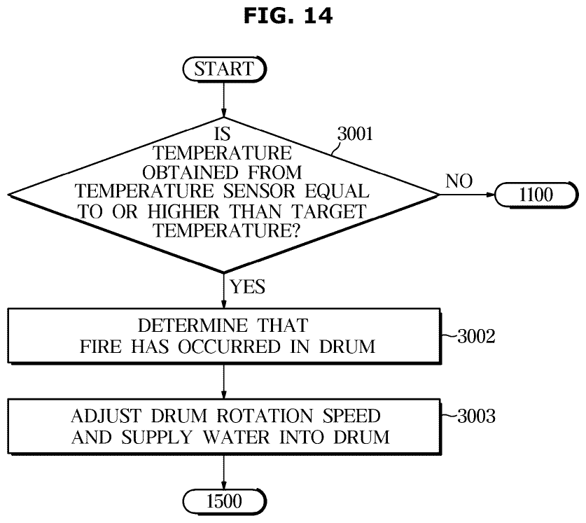

On the other hand, when a malfunction of the temperature sensor is not detected, that is, when the plurality of temperature sensors are identified as normal (No in operation 1100), the controller 80 may determine whether a fire has occurred inside the drum in operation 1300. According to an embodiment, the controller 80 may determine whether a fire has occurred based on whether the temperature obtained from any one of the plurality of temperature sensors 86a and 86b is equal to or higher than a target temperature. When it is determined that a fire has occurred, the controller 80 may perform a fire extinguishing operation in operation 1400. A detailed method of detecting a fire and performing a fire extinguishing operation will be described with reference to FIG. 14.

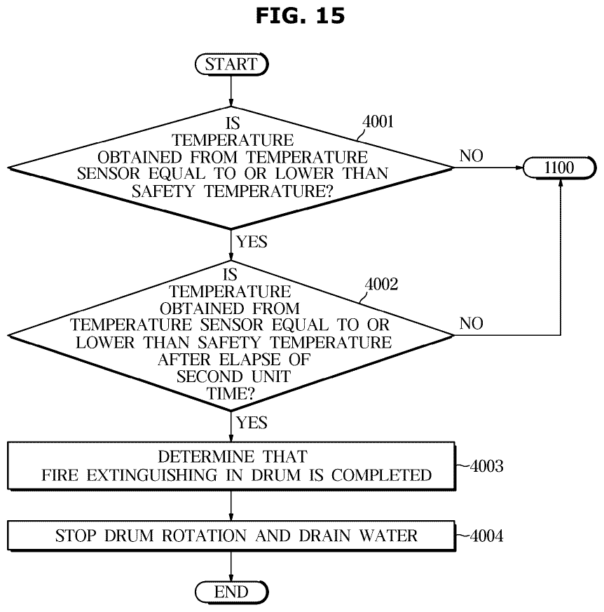

After performing the fire extinguishing operation, the controller 80 may determine whether fire extinguishing has been completed in operation 1500. According to an embodiment, the controller 80 may determine whether fire extinguishing is complete based on whether the temperature obtained from any one of the plurality of temperature sensors 86a and 86b is equal to or lower than a defined safety temperature. A method of determining the completion of fire extinguishing will be described in detail with reference to FIG. 15.

FIG. 13 is a flowchart illustrating a process of identifying an abnormality of a temperature sensor in a method of controlling a clothes treating apparatus according to an embodiment of the disclosure.

Referring to FIG. 13, the clothes treating apparatus 1 may include a plurality of temperature sensors 86a and 86b. For example, the plurality of temperature sensors 86a and 86b may include a first temperature sensor 86a and a second temperature sensor 86b.

For instance, the first temperature sensor 86a and the second temperature sensor 86b may be positioned on the same cross-section of the discharge flow path 146. In other words, the first temperature sensor 86a and the second temperature sensor 86b may be located at positions spaced the same distance from the start point of the discharge flow path 146.

According to an embodiment, the controller 80 may obtain a first temperature from the first temperature sensor and a second temperature from the second temperature sensor in operation 2001. Specifically, the controller 80 may obtain the first and second temperatures at the same point in time.

The controller 80 may determine whether the difference between the first temperature and the second temperature is equal to or greater than a defined threshold value in operation 2002. In this case, the first temperature and the second temperature may correspond to the temperatures obtained from the first temperature sensor 86a and the second temperature sensor 86b, respectively, at the same defined point in time. The defined threshold value may be defined based on a temperature difference that may occur between the plurality of temperature sensors 86a and 86b when at least one of the plurality of temperature sensors 86a and 86b is abnormal. For example, the defined threshold value may be 20° C.

When the difference between the first temperature and the second temperature is less than the defined threshold (No in operation 2002), the controller 80 may identify the plurality of temperature sensors 86a and 86b as normal in operation 2003.

On the other hand, when the difference between the first temperature and the second temperature is equal to or greater than the defined threshold (Yes in operation 2002), the controller 80 may determine whether the difference between the temperatures obtained from the plurality of temperature sensors after a first unit time is equal to or greater than the defined threshold in operation 2004. Here, the first unit time may be defined as an appropriate duration during which a change in the temperature difference between the first temperature and the second temperature may occur. For example, the first unit time may be set to 3 seconds.

When the difference in the temperatures obtained from the plurality of temperature sensors after the first unit time is less than the defined threshold (No in operation 2004), the controller 80 may identify the plurality of temperature sensors 86a and 86b as normal in operation 2003.

Conversely, when the difference in the temperatures obtained from the plurality of temperature sensors after the first unit time is equal to or greater than the defined threshold (Yes in operation 2004), the controller 80 may identify at least one of the temperature sensors 86a and 86b as abnormal in operation 2005.

The clothes treating apparatus 1 according to the disclosure may enhance the system reliability by rapidly detecting, through comparison of the temperatures obtained from the plurality of temperature sensors 86a and 86b, whether one of the sensors is malfunctioning or outputting an abnormal value.

FIG. 14 is a flowchart illustrating a process of detecting a fire and performing a fire extinguishing operation in a method of controlling a clothes treating apparatus according to an embodiment of the disclosure.

Referring to FIG. 14, the controller 80 may determine whether a temperature obtained by any one of the plurality of temperature sensors 86a and 86b is equal to or greater than a defined target temperature in operation 3001 based on the plurality of temperature sensors 86a and 86b having been identified as normal. The temperature sensor 86 configured to obtain a temperature for determining whether the temperature is equal to or higher than the target temperature may be one of the first temperature sensor 86a and the second temperature sensor 86b. For example, a temperature sensor 86 among the plurality of temperature sensors 86a and 86b configured to obtain a temperature for determining whether the temperature is equal to or higher than the target temperature may be predefined. Additionally, a temperature sensor among the plurality of temperature sensors 86a and 86b configured to obtain a temperature for determining whether the temperature is equal to or higher than the target temperature may be a temperature sensor that first reaches the target temperature among the plurality of sensors 86a and 86b. In this case, the target temperature may be defined as an appropriate temperature of heated air that flows from the drum 30 into the discharge flow path 146 as a result of a fire occurring inside the drum 30. For example, the target temperature may be set to 80° C.

In various embodiments, the controller 80 may determine whether the average of the first and second temperatures obtained from the plurality of temperature sensors 86a and 86b is equal to or greater than a defined target temperature based on the plurality of temperature sensors 86a and 86b being identified as normal.

The controller 80 may determine that no fire has occurred inside the drum 30 when the temperature obtained by any one of the plurality of temperature sensors 86a and 86b is lower than the defined target temperature (No in operation 3001), based on the plurality of temperature sensors 86a and 86b being identified as normal. Thereafter, the controller 80 may continue to detect sensor malfunction and monitor fire occurrence.

The controller 80 may, when the temperature obtained by any one of the plurality of temperature sensors 86a and 86b based on the plurality of temperature sensors 86a and 86b being identified as normal is equal to or greater than the defined target temperature (Yes in operation 3001), determine that a fire has occurred inside the drum 30 in operation 3002. Accordingly, the controller 80 may perform a fire extinguishing operation.

According to an embodiment, the controller 80 may control the driving device 36 and/or the water supply device 40 to perform the fire extinguishing operation 3003. Specifically, the controller 80 may control the driving device 36 to rotate the drum 30 at a defined rotational speed. When the drum 30 rotates at high speed during the fire extinguishing operation, changes in internal air pressure may cause external air to flow into the drum 30, making fire suppression more difficult. Therefore, the defined rotational speed may be predefined such that external air does not flow into the drum 30, while increasing the contact time or frequency between the burning laundry (or drying object) and water inside the drum 30. For example, the defined rotational speed may be slower than the speed at which the drum 30 rotates during the spin-drying cycle. As another example, the defined rotational speed may be slower than the rotational speed of the drum 30 when the temperature obtained from any one of the plurality of sensors 86a and 86b is less than the defined target temperature. Alternatively, the defined rotational speed may be set to a value between 45 rpm and 55 rpm.

In addition, the controller 80 may control the water supply device 40 to supply water into the drum 30. According to an embodiment, the rotation of the drum 30 at the defined speed and the supply of water into the drum 30 may be performed simultaneously or sequentially. For example, the controller 80 may control the water supply device 40 and the driving device 36 such that water is supplied into the drum 30 while the drum rotates at the defined speed. Alternatively, the controller 80 may control the water supply device 40 and the driving device 36 to start supplying water into the drum 30 and then, after a certain amount of time, rotate the drum 30 at the defined speed.

In various embodiments, the controller 80 may control the water supply device 40 to adjust the flow rate of water supplied into the drum 30 based on the temperature obtained from any one of the plurality of temperature sensors 86a and 86b. For example, the controller 80 may increase the flow rate of water supplied into the drum 30 as the temperature obtained from any one of the plurality of temperature sensors 86a and 86b becomes higher than the target temperature.

In various embodiments, the controller 80 may control the water supply device 40 to adjust the flow rate of water supplied into the drum 30 based on the amount of laundry (or drying object) accommodated inside the drum 30. For instance, the controller 80 may increase the flow rate of water supplied into the drum 30 as the amount of laundry (or drying object) inside the drum 30 increases.

The controller 80 may determine the amount of laundry (or drying object) accommodated in the drum 30 before or during the drying cycle.

According to an embodiment, the controller 80 may stop the operation of the hot air supply device 110 before controlling the driving device 36 and the water supply device 40 based on the temperature equal to or higher than the defined target temperature. Thus, the controller 80 may block the supply of heated air into the drum 30, thereby preventing the fire from spreading.

According to an embodiment, the controller 80 may control the water supply device 40 to stop the supply of water into the drum 30 based on the lapse of a defined reference time. The defined reference time may be predefined as an appropriate duration for fire extinguishing the fire. For example, the reference time may be set to a value between 9 and 10 minutes.

According to another embodiment, the controller 80 may control the water supply device 40 to stop the supply of water into the drum 30 based on the water level having reached a threshold level. In this case, the controller 80 may detect whether the threshold level has been reached using various sensors (e.g., a water level sensor) installed inside the drum 30.

FIG. 15 is a flowchart illustrating a process of determining whether fire extinguishment is completed in a method of controlling a clothes treating apparatus according to an embodiment of the disclosure.

Referring to FIG. 15, the controller 80 may determine whether the fire extinguishment has been completed after performing the fire extinguishing operation. The controller 80 may determine the completion of extinguishment based on the temperature acquired from any one of the plurality of temperature sensors 86a and 86b.

According to an embodiment, the controller 80 may determine whether the temperature obtained by any one of the temperature sensors 86a and 86b is equal to or lower than a defined safety temperature in operation 4001. The temperature sensor 86 configured to obtain a temperature for determining whether the temperature is equal to or higher than the defined safety temperature may be one of the first temperature sensor 86a and the second temperature sensor 86b. For example, the temperature sensor 86 configured to obtain a temperature for determining whether the temperature is equal to or higher than the defined safety temperature may be the same as the sensor configured to obtain a temperature for determining whether the temperature is equal to or higher than the target temperature. For example, any one temperature sensor 86a among the plurality of temperature sensors 86a and 86b configured to obtain a temperature for determining whether the temperature is equal to or higher than the defined safety temperature may be predefined. That is, any one temperature sensor 86a among the plurality of temperature sensor 86a and 86b configured to obtain a temperature for determining whether the temperature is equal to or higher than the target temperature may be one of the first temperature sensor 86a and the second temperature sensor 86b. In addition, any one temperature sensor among the plurality of temperature sensors 86a and 86b configured to obtain a temperature for determining whether the temperature is equal to or higher than the target temperature may be a temperature sensor that first reaches the defined safety temperature among the plurality of sensors 86a and 86b. In this case, the defined safety temperature may be set in advance as an appropriate temperature of the heated air flowing from the drum 30 into the discharge flow path 146 after extinguishment has been completed inside the drum 30. For example, the defined safety temperature may be 55° C.

In various embodiments, the controller 80 may determine whether the average temperature of the first temperature and the second temperature obtained from the plurality of temperature sensors 86a and 86b, respectively, exceeds the defined safety temperature.

When the temperature obtained by any one of the temperature sensors 86a and 86b exceeds the defined safety temperature (No in operation 4001), the controller 80 may determine that extinguishment is incomplete. Accordingly, the controller 80 may repeat the above-described fire extinguishing operation.

When the temperature obtained by any one of the temperature sensors 86a and 86b is equal to or lower than the defined safety temperature (Yes in operation 4001), the controller 80 may, after a second unit time has elapsed, determine whether the temperature obtained from any one of the plurality of temperature sensors remains equal to or lower than the defined safety temperature in operation 4002. In this case, the second unit time may be defined as an appropriate duration in which a change in the temperature difference between the first and second temperatures may occur after the fire extinguishing operation is performed. For example, the second unit time may be 60 seconds.

The controller 80 may determine that extinguishment is incomplete when, after the second unit time has elapsed, the temperature obtained by any one of the temperature sensors 86a and 86b exceeds the defined safety temperature. Accordingly, the controller 80 may repeat the above-described fire extinguishing operation.

The controller 80 may determine that the fire inside the drum 30 has been completely extinguished when, after the second unit time has elapsed, the temperature obtained by any one of the temperature sensors 86a and 86b is equal to or lower than the defined safety temperature in operation 4003.

Accordingly, the controller 80 may control the driving device 36 to stop the rotation of the drum 30, and control the drainage device 70 to drain the water supplied into the drum 30 in operation 4004, based on the determination that fire extinguishment has been completed inside the drum 30.

A clothes treating apparatus 1 according to an embodiment may include: a housing 10; a tub 20 provided inside the housing 10; a drum 30 provided inside the tub 20 and configured to accommodate laundry; a driving device 36 configured to provide rotational force to the drum 30; a water supply device 40 configured to supply water from an external water source into the tub 20; a hot air supply device 110 including a heater 120 configured to heat air and a fan 130 configured to blow the air heated by the heater 120 into the tub 20; a discharge device 140 including a discharge flow path 146 configured to guide moist air discharged from the tub 20 to the outside; a plurality of temperature sensors 86 provided on the discharge flow path 146 of the discharge device 140 and configured to detect a temperature; and a controller 80 configured to perform a drying operation by driving the hot air supply device 110, wherein the controller 80 may be configured to control the driving device 36 such that the drum 30 rotates at a defined rotational speed and to control the water supply device 40 to supply water into the drum 30, based on a temperature detected by one of the plurality of temperature sensors 86 being equal to or higher than a defined target temperature.

The defined rotational speed may be lower than a rotational speed of the drum 30 during a spin-drying operation.

The controller 80 may be configured to stop driving the hot air supply device 110 before controlling the driving device 36 and the water supply device 40, based on a temperature detected by one of the plurality of temperature sensors 86 being equal to or higher than the defined target temperature.

The controller 80 may be configured to control the water supply device 40 to stop supplying the water into the drum 30 based on a defined reference time having elapsed.

The controller 80 may be configured to control the water supply device 40 to stop supplying the water into the drum 30 based on the water having been supplied up to a threshold water level in the drum.

The controller 80 may be configured to control an output interface 15b to output a guide interface related to ending the drying operation based on any one of the plurality of temperature sensors 86 being identified as abnormal during the drying operation, and to determine whether a temperature detected by any one of the plurality of temperature sensors 86 is equal to or higher than the defined target temperature, based on the plurality of temperature sensors 86 being identified as normal during the drying operation.

The controller 80 may be configured to identify the plurality of temperature sensors 86 as normal based on a difference in temperatures obtained from the plurality of temperature sensors 86 being less than a defined threshold, and to determine whether the difference in temperatures obtained from the plurality of temperature sensors 86 is equal to or greater than the defined threshold after a first unit time has elapsed, based on the difference in temperatures being equal to or greater than the defined threshold.

The controller 80 may be configured to identify the plurality of temperature sensors 86 as normal based on the difference in temperatures obtained from the plurality of temperature sensors 86 being less than the defined threshold after the first unit time has elapsed, and to identify at least one of the plurality of temperature sensors 86 as abnormal based on the difference in temperatures obtained from the plurality of temperature sensors 86 being equal to or greater than the defined threshold after the first unit time has elapsed.

The controller 80 may be configured to determine whether a temperature detected by one of the plurality of temperature sensors 86 is equal to or lower than a defined safety temperature after a second unit time has elapsed, based on a temperature detected by one of the plurality of temperature sensors 86 being equal to or lower than the defined safety temperature.

The controller 80 may be configured to determine that fire extinguishing inside the drum 30 is completed based on a temperature detected by one of the plurality of temperature sensors 86 being equal to or lower than the defined safety temperature after the second unit time has elapsed.

The controller 80 may be configured to control the driving device 36 to stop rotation of the drum 30 and to control the drainage device 70 to drain the water supplied into the drum 30, based on the determination that fire extinguishing inside the drum 30 is completed.

In a method of controlling a clothes treating apparatus 1 which includes: a housing 10; a tub 20 provided inside the housing 10; a drum 30 provided inside the tub 20 and configured to accommodate laundry; a driving device 36 to provide rotational force to the drum 30; a water supply device 40 to supply water from an external water source into the tub 20; a hot air supply device 110 including a heater 120 for heating air and a fan 130 for blowing the heated air into the tub 20; a discharge device 140 including a discharge flow path 146 for guiding moist air from the tub 20 to the outside; and a plurality of temperature sensors 86 provided on the discharge flow path 146 of the discharge device 140 to detect a temperature, the method may comprise: performing a drying operation by driving the hot air supply device 110; and controlling the driving device 36 such that the drum 30 rotates at a defined rotational speed and controlling the water supply device 40 to supply water into the drum 30, based on a temperature detected by any one of the plurality of temperature sensors 86 being equal to or higher than a defined target temperature.

The defined rotational speed may be lower than a rotational speed of the drum 30 during a spin-drying operation.

The method of controlling the clothes treating apparatus 1 may further comprise stopping driving of the hot air supply device 110 before controlling the driving device 36 and the water supply device 40, based on a temperature detected by any one of the plurality of temperature sensors 86 being equal to or higher than the defined target temperature.

The method of controlling the clothes treating apparatus 1 may further comprise controlling the water supply device 40 to stop supplying the water into the drum 30 based on a defined reference time having elapsed.

The method of controlling the clothes treating apparatus 1 may further comprise controlling the water supply device 40 to stop supplying the water into the drum 30 based on the water having been supplied up to a threshold water level in the drum.

The method of controlling the clothes treating apparatus 1 may further comprise providing a guide interface for drying operation termination, based on whether any one of the plurality of temperature sensors 86 is identified as abnormal during the drying operation, and determining whether the temperature detected by any one of the plurality of temperature sensors 86 is equal to or higher than the defined target temperature, based on whether the plurality of temperature sensors 86 are identified as normal during the drying operation.

The method of controlling the clothes treating apparatus 1 may further comprise identifying the plurality of temperature sensors 86 as normal based on whether a difference in temperature obtained from the plurality of temperature sensors 86 is less than a defined threshold value, and determining whether the temperature difference obtained from the plurality of temperature sensors 86 is equal to or greater than the defined threshold value after a first unit time, based on whether the difference is equal to or greater than the defined threshold value.

The method of controlling the clothes treating apparatus 1 may include identifying the plurality of temperature sensors 86 as normal based on whether the temperature difference obtained from the plurality of temperature sensors 86 is less than the defined threshold value after the first unit time has elapsed, and identifying at least one of the plurality of temperature sensors 86 as abnormal based on whether the temperature difference is equal to or greater than the defined threshold value after the first unit time has elapsed.

The method of controlling the clothes treating apparatus 1 may include determining whether the temperature obtained by any one of the plurality of temperature sensors 86 is equal to or lower than a defined safety temperature after a second unit time has elapsed, and determining that fire suppression in the drum 30 is completed based on whether the temperature obtained by any one of the plurality of temperature sensors 86 is equal to or lower than the defined safety temperature after the second unit time has elapsed.

The disclosure can provide a clothes treating apparatus including a temperature sensor configured to detect the temperature of heated air supplied to a drum, and a method of controlling the clothes treating apparatus.

One aspect of the disclosure can provide a clothes treating apparatus with improved safety through fire detection and fire suppression operations.

Another aspect of the disclosure can provide a clothes treating apparatus with enhanced accuracy in fire prediction by identifying abnormalities of the temperature sensor.

The technical objectives of the disclosure are not limited to the above, and other objectives that are not described above will be clearly understood by those skilled in the art from the above detailed description.

Meanwhile, the disclosed embodiments may be embodied in the form of a recording medium storing instructions executable by a computer. The instructions may be stored in the form of program code and, when executed by a processor, may generate a program module to perform the operations of the disclosed embodiments. The recording medium may be embodied as a computer-readable recording medium.

The computer-readable recording medium includes all kinds of recording media in which instructions which may be decoded by a computer are stored, for example, a Read Only Memory (ROM), a Random Access Memory (RAM), a magnetic tape, a magnetic disk, a flash memory, an optical data storage device, and the like.

The computer-readable recording medium may be provided in the form of a non-transitory storage medium. Here, when a storage medium is referred to as “non-transitory,” it can be understood that the storage medium is tangible and does not include a signal (electromagnetic waves), but rather that data is semi-permanently or temporarily stored in the storage medium. For example, a ‘non-temporary storage medium’ may include a buffer in which data is temporarily stored.

According to one embodiment, the methods according to the various embodiments disclosed herein may be provided in a computer program product. The computer program product may be traded between a seller and a buyer as a product. The computer program product may be distributed in the form of a machine-readable storage medium (e.g., compact disc read only memory (CD-ROM)), or may be distributed through an application store (e.g., Play Store™) online. In the case of online distribution, at least a portion of the computer program product may be stored at least semi-permanently or may be temporarily generated in a storage medium, such as memory of a server of a manufacturer, a server of an application store, or a relay server.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A clothes treating apparatus comprising:
a housing;
a tub provided inside the housing;
a drum provided inside the tub and configured to accommodate laundry;
a driving device configured to provide rotational force to the drum;
a water supply device configured to supply water from an external water source into the tub;
a hot air supply device including a heater configured to heat air and a fan configured to blow the air heated by the heater into the tub;
a discharge device including a discharge flow path configured to guide moist air discharged from the tub to the outside;
a plurality of temperature sensors provided on the discharge flow path of the discharge device and configured to detect a temperature;
memory, comprising one or more storage media, storing instructions; and
one or more processors communicatively coupled to the driving device, the water supply device, the hot air supply device, the plurality of temperature sensors, and the memory,
wherein the instructions, when executed by the one or more processors individually or collectively, cause the clothes treating apparatus to:
control the driving device such that the drum rotates at a defined rotational speed, and
control the water supply device to supply water into the drum, based on a temperature detected by one of the plurality of temperature sensors being equal to or higher than a defined target temperature.

2. The clothes treating apparatus of claim 1, wherein the defined rotational speed is lower than a rotational speed of the drum during a spin-drying operation.

3. The clothes treating apparatus of claim 1, wherein the instructions, when executed by the one or more processors individually or collectively, further cause the clothes treating apparatus to stop driving the hot air supply device before controlling the driving device and the water supply device, based on the temperature detected by one of the plurality of temperature sensors being equal to or higher than the defined target temperature.

4. The clothes treating apparatus of claim 1, wherein the instructions, when executed by the one or more processors individually or collectively, further cause the clothes treating apparatus control the water supply device to stop supplying water into the drum based on a defined reference time having elapsed.

5. The clothes treating apparatus of claim 1, wherein the instructions, when executed by the one or more processors individually or collectively, further cause the clothes treating apparatus to control the water supply device to stop supplying water into the drum based on the water having been supplied to a threshold water level in the drum.

6. The clothes treating apparatus of claim 1, further comprising:
an output interface configured to output information regarding an operation of the clothes treating apparatus,
wherein the instructions, when executed by the one or more processors individually or collectively, further cause the clothes treating apparatus to:
control the output interface to output a guide interface related to ending a drying operation based on one of the plurality of temperature sensors being identified as abnormal during the drying operation, and
determine whether a temperature detected by one of the plurality of temperature sensors is equal to or higher than the defined target temperature, based on the plurality of temperature sensors being identified as normal during the drying operation.

7. The clothes treating apparatus of claim 6, wherein the instructions, when executed by the one or more processors individually or collectively, further cause the clothes treating apparatus to:
identify the plurality of temperature sensors as normal based on a difference in temperatures among the plurality of temperature sensors being less than a defined threshold; and
determine whether the difference in temperatures among the plurality of temperature sensors is equal to or greater than the defined threshold after a first unit time has elapsed, based on the difference in temperatures being equal to or greater than the defined threshold.

8. The clothes treating apparatus of claim 7, wherein the instructions, when executed by the one or more processors individually or collectively, further cause the clothes treating apparatus to:
identify the plurality of temperature sensors as normal based on the difference in temperatures among the plurality of temperature sensors being less than the defined threshold after the first unit time has elapsed; and
identify at least one of the plurality of temperature sensors as abnormal based on the difference in temperatures among the plurality of temperature sensors being equal to or greater than the defined threshold after the first unit time has elapsed.

9. The clothes treating apparatus of claim 1, wherein, after a second unit time has elapsed, based on a temperature detected by one of the plurality of temperature sensors being equal to or lower than a defined safety temperature, the instructions, when executed by the one or more processors individually or collectively, further cause the clothes treating apparatus to determine whether a temperature detected by one of the plurality of temperature sensors is equal to or lower than the defined safety temperature.

10. The clothes treating apparatus of claim 9, wherein instructions, when executed by the one or more processors individually or collectively, further cause the clothes treating apparatus to determine that fire extinguishing inside the drum is completed based on a temperature detected by one of the plurality of temperature sensors being equal to or lower than the defined safety temperature after the second unit time has elapsed.

11. The clothes treating apparatus of claim 9, further comprising:
a drainage device configured to discharge water accommodated in the tub to the outside,
wherein instructions, when executed by the one or more processors individually or collectively, further cause the clothes treating apparatus to control the driving device to stop rotation of the drum and control the drainage device to drain the water supplied into the drum, based on the determination that fire extinguishing inside the drum is completed.

12. A method of controlling a clothes treating apparatus, wherein the clothes treating apparatus comprises:
a housing;
a tub provided inside the housing;
a drum provided inside the tub and configured to accommodate laundry;
a driving device configured to provide rotational force to the drum;
a water supply device configured to supply water from an external water source into the tub;
a hot air supply device including a heater for heating air and a fan for blowing the heated air into the tub;
a discharge device including a discharge flow path for guiding air discharged from the tub to the outside; and
a plurality of temperature sensors provided on the discharge flow path of the discharge device and configured to detect a temperature,
wherein the method comprises:
performing a drying operation by driving the hot air supply device,
controlling the driving device such that the drum rotates at a defined rotational speed, and
controlling the water supply device to supply water into the drum, based on a temperature detected by one of the plurality of temperature sensors being equal to or higher than a defined target temperature.

13. The method of claim 12, wherein the defined rotational speed is lower than a rotational speed of the drum during a spin-drying operation.

14. The method of claim 12, further comprising:
stopping driving of the hot air supply device before the controlling of the driving device and the water supply device, based on the temperature detected by one of the plurality of temperature sensors being equal to or higher than the defined target temperature.

15. The method of claim 12, further comprising:
controlling the water supply device to stop supplying water into the drum based on elapse of a defined reference time.

16. The method of claim 12, further comprising:
controlling the water supply device to stop supplying water into the drum based on the water having been supplied to a threshold water level in the drum.

17. The method of claim 12, further comprising:
controlling an output interface of the clothes treating apparatus to output a guide interface related to ending the drying operation based on one of the plurality of temperature sensors being identified as abnormal during the drying operation, and
determining whether a temperature detected by one of the plurality of temperature sensors is equal to or higher than the defined target temperature, based on the plurality of temperature sensors being identified as normal during the drying operation.

18. The method of claim 12, further comprising:
obtaining temperatures from the plurality of temperature sensors;
identifying the plurality of temperature sensors as normal based on a difference in temperatures among the plurality of temperature sensors being less than a defined threshold; and
based on the plurality of temperature sensors being identified as normal and the obtained temperature from one or more temperature sensors is equal to or greater than a defined target temperature, determining that a fire has occurred inside the drum in operation.

19. One or more non-transitory computer-readable storage media storing one or more computer programs including computer-executable instructions that, when executed by one or more processors of a clothes treating apparatus individually or collectively, cause the clothes treating apparatus to perform operations, the operations comprising:
performing a drying operation by driving a hot air supply device,
controlling a driving device such that a drum rotates at a defined rotational speed, and
controlling a water supply device to supply water into the drum, based on a temperature detected by one of a plurality of temperature sensors being equal to or higher than a defined target temperature.

20. The one or more non-transitory computer-readable storage media of claim 19, the operations further comprising:
stopping the driving of the hot air supply device before the controlling of the driving device and the water supply device, based on the temperature detected by one of the plurality of temperature sensors being equal to or higher than the defined target temperature.
